(19) United States
(12) Patent Application Publication
(10) Pub. No.: US 2025/0018364 A1
(43) Pub. Date: Jan. 16, 2025

(54) MODIFIED BIOCHAR/COAL LIGNITES AND THEIR USE IN PHOSPHATE REMEDIATION AND AS SOLID AMENDMENTS

(71) Applicants: THE GEORGE WASHINGTON UNIVERSITY, Washington, DC (US); MISSISSIPPI STATE UNIVERSITY, Mississippi State, MS (US)

(72) Inventors: Richard Clive MILLAR, Lexington Park, MD (US); Todd MLSNA, Mississippi State, MS (US); Sita WARREN, Lexington Park, MD (US)

(73) Assignees: THE GEORGE WASHINGTON UNIVERSITY, Washington, DC (US); MISSISSIPPI STATE UNIVERSITY, Mississippi State, MS (US)

(21) Appl. No.: 18/711,678

(22) PCT Filed: Nov. 22, 2022
(86) PCT No.: PCT/US2022/080337

§ 371 Date: May 20, 2024

Related U.S. Application Data
(60) Provisional application No. 63/282,052, filed on Nov. 22, 2021.

(51) Int. Cl. B01J 20/20; B01J 20/28; B01J 20/30; B01J 20/34; C02F 1/28; C05G 5/40; C02F 101/10; C02F 103/00

(52) U.S. Cl. CPC B01J 20/20; B01J 20/28004; B01J 20/28016; B01J 20/3021; B01J 20/3071; B01J 20/3078; B01J 20/3085; B01J 20/3416; B01J 20/3475; C02F 1/286; C05G 5/40; C02F 2101/105; C02F 2103/001; C02F 2303/16

(57) ABSTRACT

The present disclosure relates to improved processes for preparing modified lignite by reacting raw lignite with a source of magnesium (Mg2+) ions and a source of calcium (Ca2+) ions, washing the modified lignite (e.g., with water), drying, and pyrolyzing the treated lignite, and to the use of such products for phosphorous remediation.

### CROSS REFERENCE TO RELATED APPLICATIONS

This application claims the benefit of U.S. Provisional Application No. 63/282,052, filed Nov. 22, 2021, the entire contents of which is hereby incorporated by reference.

### STATEMENT REGARDING FEDERALLY SPONSORED RESEARCH OR DEVELOPMENT

At least some aspects of this invention were made with Government support from the National Science Foundation INFEWS REU Program under Grant No. 1852527. The Government has certain rights in this invention.

### FIELD OF THE INVENTION

The present invention relates to improved processes for preparing modified biochar/coal lignite, and to the use of such products for phosphorous remediation and as soil adsorbents/fertilizers.

### BACKGROUND OF THE INVENTION

Commercial fertilizer and manures are known for aiding plant growth and development, but their continued usage has been linked to environment and economic challenges.

Eutrophication, resulting from the nutrient enrichment of waters, is a current global crisis (Nixon, 2012). Phosphorous, a limiting plant nutrient widely applied in agriculture worldwide, often contaminates stormwater run-off. Environmental aqueous phosphate in concentrations as low as 100 μg/L can stimulate undesirable algal and plant blooms. These blooms lead to water quality deterioration, dissolved oxygen deficiency, biodiversity abatement, and economic losses (Zanchett and Oliveira-Filho, 2013). Annually, the US spends $2.2 billion to combat freshwater eutrophication (Dodds et al., 2009). Phosphorus regulation is essential to mitigate eutrophication. The WHO and EPA recommend that phosphorus levels should be lower than 10 mg/L in natural waters (US EPA, 2015), while phosphate concentrations should be below 0.10 mg/L in rivers and streams and below 0.05 mg/L in lakes and reservoirs, according to the Australian water quality guidelines (Huang et al., 2017). Phosphate recycling and recovery will eventually be necessary for problematic phosphorus depletion.

Phosphorous is discharged into surface waters from point source wastewater and nonpoint source run-off. Typically, municipal wastewater has approximately 5-20 mg/L total phosphorus (organic and inorganic) concentration before treatment (Hasson et al., 2016). Inorganic phosphorus mainly exists as PO₄³⁻, HPO₄²⁻, and H₂PO₄⁻, depending on the solution pH (Yin et al., 2017). Traditional precipitation, reduction, flotation, coagulation, flocculation, and membrane filtration methods have many drawbacks, including initial investment, chemical consumption, efficiency, simplicity, and scalability (Leo et al., 2011). Efficient, practical, green, and restorable techniques have been developed for contaminant removal (Bombuwala Dewage et al., 2018). After adsorptive recovery, adsorbed phosphates have been reused as soil fertilizers, making sorption technology more ecofriendly (Mosa et al., 2020). Phosphate recovery from wastewater treatment plants (WWTP) can theoretically replace 40-50% of total phosphate application needs.

Coal seams are abundant, and various grades of coal can be employed as a support/sorbent to remove contaminants from aqueous solutions (Simate et al., 2016). Aqueous Cu²⁺, Pb²⁺, and Ni²⁺ ions were fixed by surface carboxyl and hydroxyl groups (˜60-90%) on low-rank coal lignite because of its elevated cation exchange capacity and surface complexation ability (Pehlivan and Arslan, 2007). However, these oxygenated active centers have low affinities for anionic pollutants (Qi et al., 2011; Zhang et al., 2010). Introduction of Al³⁺, Ca²⁺, Bi³⁺, Fe³⁺, and Mg²⁺ to cation-deficient adsorbent surfaces previously raised phosphate removal (Fang et al., 2020; Karunanayake et al., 2019; Yang et al., 2018; Zhang et al., 2013; Zhou et al., 2013).

Yao et al., 2013 found that spent Mg-enriched tomato leaf char sorbents were successfully reused even after 10 sorption cycles and employed to treat phosphorus deficiency in soils. Equal amounts of weakly-bound P (˜3.2% of the amount of PO₄³⁻ on this char) were released to water each day (average/day) over 11 consecutive days. Therefore, it behaved as a slow-release fertilizer (Yao et al., 2013). These modified, environmentally friendly sorbents could sequester C in soils and are more beneficial than commercial adsorbents. Colloidal and nano-sized MgO and Mg(OH)₂ surface particles on anaerobically digested sugar beet biochar improved mononuclear and polynuclear phosphate adsorption (Zhang et al., 2012). MgO-modified peanut shell biochar adsorbed 20% more PO₄³⁻ than raw peanut shell biochar due to the presence of MgO active surface sites. The application of P-laden MgO-biochar to coastal alkaline soils improved the available P (phosphorous) and P uptake by field rice plants, which increased rice yields (Wu et al., 2019). Ca₂₊ was released from alkaline Ca-doped biochar (Ca(OH)₂: biosolids, 20 wt. %) at pH=4, into a solution where it reacts with phosphate to form insoluble brushite (CaHPO₄), which precipitated (Antunes et al., 2018). The maximum phosphate removal capacity of this biochar was 79 mg-P/g (at initial pH=3). Elevated phosphate sorption was achieved by a novel Mg(OH)₂/ZrO₂ composite (MZ) resulting from both i) ligand exchange between the ZrO₂ and MgHPO₄ and ii) reaction between Mg(OH)₂ and phosphate forming MgHPO₄ and Mg₃(PO₄)₂ (Lin et al., 2019). Dissolved Mg²⁺ originating from the Mg(OH)₂ also synergistically enhanced the phosphate-binding on the ZrO₂ component in MZ. Ca²⁺-Mg2+ pre-loaded (19 wt. % Mg²⁺ and 19 wt. % Ca²⁺/biomass) on corncob biochar had a very high (326 mg/g) Langmuir phosphate uptake capacity.

However, there still remains a need for new methods to modify cheaper and widely available lignite to remove aqueous phosphates.

### SUMMARY OF THE INVENTION

The present inventor has surprisingly found that locally abundant raw lignite (RL) may be converted into a chemically and thermally modified lignite (CTL) by reacting (e.g., via a surface deposition treatment) with Mg²⁺ (e.g., using MgSO₄, MgO, Mg(OH)₂) and Ca²⁺ (e.g., using CaSO₄, CaO, Ca(OH)₂) followed by pyrolysis (e.g., at 600° C.). Without wishing to be bound by theory, the inventor theorizes that CTL prepared by such a process promotes phosphate removal form a solution due to the formation of precipitates (such as Mg₃(PO₄)₂, MgHPO₄, Ca₃(PO₄)₂, and CaHPO₄) formed upon reaction of solution phosphate with Mg²⁺ and Ca²⁺ ions released from the CTL.

Lignite-based adsorbents' high abundance, physico-chemical properties, and low-costs are attractive for traditional water treatment. These can be utilized to reduce eutrophication in natural waters by remediation of point and nonpoint sources of P.

A variety of CTLs have been developed to remove phosphate fertilizers from agriculture run off and the spent sorbent can then be recycled as a slow-release fertilizer.

Unwashed CTL could also be utilized to lower soil acidity, enhance soil fertility, and can be readily produced at a large scale in a few steps.

Accordingly, in one aspect, the present invention relates to a process for preparing a modified biochar/coal lignite (e.g., a chemically and thermally modified lignite, CTL). In one embodiment, the process comprises
(i) reacting raw lignite with a source of Mg²⁺ ions (e.g., MgSO₄) and a source of Ca²⁺ ions (e.g., CaSO₄);
(ii) optionally further reacting the lignite with a source of K⁺ ions (e.g., KOH);
(iii) optionally drying the treated lignite (using, e.g., solar kiln 128 as shown, for example, in FIG. 10a, oven 128 as shown, for example, in FIG. 10b, or oven/solar kiln 132 as shown in FIG. 11);
(iv) pyrolyzing the treated lignite (e.g., at 600° C.), thereby producing the modified lignite (using, e.g., furnace 132, as shown in FIGS. 10a and 10b, or furnace 128, as shown, for example, in FIG. 11).

In one embodiment, steps (i) and (ii) are performed sequentially. Step (ii) may be performed before step (i). In one embodiment, steps (i) and (ii) are performed simultaneously.

In one embodiment, the process further comprises
(v) washing the modified lignite (e.g., with water) (e.g., using wash spray 126 as shown, for example, in FIGS. 10a and 10b); and
(vi) optionally drying the product of step (v).

In certain embodiments, the source of Mg²⁺ ions is selected from MgSO₄, MgO, Mg(OH)₂, MgCl₂, or any combination thereof.

In certain embodiments, the source of Ca²⁺ ions is selected from CaSO₄, CaO, Ca(OH)₂, CaCl₂), or any combination thereof.

In certain embodiments, the source of K⁺ ions is selected from KOH, KCl, or any combination thereof.

In one embodiment, step (iii), if performed, is conducted at about 105° C.

In one embodiment, step (iii), if performed, is conducted for about 4 hours

In one embodiment, pyrolysis step (iv) is conducted at about 600° C. In certain embodiments, pyrolysis step (iv) is conducted under an intern atmosphere (e.g., nitrogen, argon).

In certain embodiments, step (v), if performed, involves washing the modified lignite with water (e.g., distilled water).

In one embodiment, step (iii), if performed, is conducted at about 80° C.

In certain embodiments, step (ci), if performed, is conducted for between about 12 and about 24 hours, such as between about 18 and about 24 hours. In one embodiment, step (vi), if performed, is conducted overnight (e.g., for about 18 hours).

In additional embodiments, the process further comprises
(vii) reducing the particle size of the modified lignite (e.g., by crushing and/or sieving) (using e.g., grinder 124 as shown in FIG. 11).

In one embodiment, the modified lignite has a particle size of less than about 150 microns. In one embodiment, the modified lignite has a particle size of between about 150 microns and about 300 microns. In one embodiment, the modified lignite has a particle size of greater than about 300 microns.

In a second aspect, the present invention relates to a process for reducing the amount of phosphate in a solution (such as a water source, e.g., wastewater or contaminated water, such as mining wastewater). In one embodiment, the process comprises
(i) contacting the solution with a modified lignite prepared by a process according to any of the embodiments described herein, thereby allowing the modified lignite to adsorb phosphorous from the solution, producing phosphate laden modified lignite.

In a third aspect, the present invention relates to a process for removing agricultural waste (e.g., phosphates) from a solution (such as a water source, e.g., wastewater or contaminated water, such as mining wastewater). In one embodiment, the process comprises contacting the solution with a modified lignite (e.g., a modified lignite prepared by a process according to any of the embodiments described herein, thereby producing phosphate laden modified lignite.

In one embodiment, the process of the second and third aspects further comprise a fourth aspect, regenerating the modified lignite. In certain embodiments, the regeneration process comprises
(ii) removing the phosphate laden modified lignite from the solution (e.g., by filtration);
(iii) washing the phosphate laden modified lignite (e.g., with water) (e.g., to remove unadsorbed phosphate and only hydrogen bonded phosphate on the lignite surface); (iv) drying the product of step (iii) (e.g., at 105° C.);
(v) washing the product of step (iv) with an alkali (such as NaOH) or an acid (such as hydrochloric acid), thereby regenerating the modified lignite; and
(vi) drying the product of step (v) (e.g., at 105° C.).

In additional embodiments, the process of aspect 2 (or aspect 3) followed by the process of aspect 4 is conducted more than one time, such as two, three, four or five times (i.e., the process in which modified lignite adsorbs phosphate then is regenerated is repeated more than one time).

In a fifth aspect, the present invention relates to a process for preparing a fertilizer and/or soil amendment (e.g., a slow release fertilizer and/or soil amendment). In one embodiment, the process comprises
(i) reacting raw lignite with a source of Mg²⁺ ions (e.g., MgSO₄) and a source of Ca²⁺ ions (e.g., CaSO₄);
(ii) optionally further reacting the lignite with a source of K⁺ ions (e.g., KOH);
(iii) optionally drying the treated lignite;
(iv) pyrolyzing the treated lignite (e.g., at 600 C);
(v) contacting the product of step (iv) with a solution containing phosphorous (such as a water source, e.g., wastewater or contaminated water, such as mining wastewater);
(vi) allowing the treated lignite to adsorb phosphorous from the solution; and
(vii) drying the product of step (vi) (e.g., at 105° C.).

Accordingly, in a sixth aspect, the present invention relates to a process for preparing a modified biochar/coal (e.g., a modified biochar/coal useful as a fertilizer/soil amendment/soil additive). In one embodiment, the process comprises
(i) reacting biochar (e.g., Douglas fir)/coal with a source of Mg²⁺ ions (e.g., MgSO₄);
(ii) optionally further reacting the biochar/coal with a source of K⁺ ions (e.g., KOH);
(iii) aging the product of step (ii) (e.g., for 24 hours at room temperature);
(iv) optionally drying the product of step (iii);
(v) adding a source of phosphorous (e.g., 10% or 20% (NH₄)₂HPO₄);
(vi) aging the product of step (v) (e.g., for 24 hours at room temperature);
(vii) optionally drying the product of step (vi).

In certain embodiments, the source of phosphorous is selected from (NH₄)₂HPO₄.

In an eighth aspect, the present invention relates to a fertilizer and/or soil amendment (e.g., a slow release fertilizer and/or soil amendment) prepared by a process according the any of the embodiments described herein. In one embodiment, and of the modified biochar/coal lignites described herein is in the form of pellets.

### BRIEF DESCRIPTION OF THE DRAWINGS

FIG. 1a shows TGA analysis of RL, TL, and washed CTL under O₂ (heating rate, 10° C./min).

FIG. 1b shows XRD analysis of RL, TL, washed CTL, and P-laden washed CTL. Phosphates were adsorbed to the CTL surface at pH 2.2

FIGS. 2a, 2b and 2c show SEM images of RL, TL, and washed CTL (15 kV, scale bar 20 μm, resolution 2.50 kX). Areas covered with circles in FIG. 2c indicate the surfaces of Mg and Ca hydroxide/oxide/carbonates of washed CTL.

FIGS. 2d, 2e, 2f, 2g, 2h and 2i show SEM-EDX mapping of washed CTL before P uptake (scale bar 20 gm, resolution 2.5 kX).

FIGS. 2j, 2k, 2l, 2m 2n and 2o show SEM-EDX mapping of washed CTL P-laden washed CTL after P uptake (scale bar 20 gm, resolution 2.5 kX). P-loaded washed CTL was prepared at pH 7, with 100 mg/L phosphate (25 mL) equilibrated with 50 mg of CTL for 1 h at 25° C. (2 g/L dose).

FIGS. 2p, 2q and 2l show SEM/EDX electron spectra for washed CTL (FIG. 2p), washed CTL (2 g/L) exposed to water at pH 2.2 (FIG. 2q), and p-laden CTL (1000 mg/L phosphate (25 mL) at pH 2.2) (FIG. 2r), depicting the surface regions elemental composition.

FIG. 3a shows a bright-field TEM image of washed CTL representing MgO (002) clusters (black) dispersed on char matrix (grey). FIG. 3b shows flake-like morphology of washed CTL was visible at high magnification, FIG. 3c depicts dark-field TEM imaging of washed CTL; white spots are MgO particles dispersed on char matrix. FIG. 3d is a high-resolution TEM image of a MgO particle showing overlapped lattice fringes (inset showed the SAED pattern of that MgO particle). FIG. 3e shows phosphate uptake from the low initial phosphate concentration (0.4 ppm, 25 mL) on (0.05 g doses) RL, TL, washed CTL (W. CTL), and unwashed CTL (U. CTL) at 25° C. for 24 h. Equilibrium phosphate concentrations after uptake are presented on the top of the blue bars.

FIG. 4a shows plots of RL, washed CTL, and TL phosphate removal efficiency (right-Y axis) and phosphate's fractional composition (left Y-axis) vs. pH at 25° C. (adsorbent dose 50 mg, 25 mL of 50 ppm [phosphate], 24 h, particle size 150-300 μm). FIG. 4b depicts equilibrium pH vs. initial pH (2.2, 7, and 10) using washed CTL at 0, 25 and 100 ppm initial phosphate concentrations. FIG. 4c shows leached Mg²⁺ concentration (ppm) and FIG. 4d shows C^{a} concentration (ppm) in the filtrates from initial solution pH values of 2.2, 7, and 10. FIGS. 4e and 4f show Sips non-linear isotherms for RL, washed CTL and TL at 40° C., pH 2.2 (FIG. 4e), 40° C., pH 7 (FIG. 4f). FIG. 4g shows Langmuir linear isotherms for washed CTL and unwashed CTL at 25° C., pH 7 (adsorbent dose 50 mg, 25 mL of 25-1000 ppm phosphate concentration, 24 h).

FIG. 5a shows washed CTL and FIG. 5b shows unwashed CTL adsorption-desorption tested for 4 cycles (adsorbent dose 50 mg, 25 mL of 1000 ppm phosphate, 24 h, pH 2.2, 40° C.). Desorption was performed using 1 M NaOH as the stripping agent. FIG. 5c shows washed CTL and FIG. 5d shows unwashed CTL adsorption-desorption tests for 4 cycles, C1-C4 (adsorbent dose 1.5 g, 750 mL of 1000 ppm phosphate, 24 h, pH 7, 25° C.). Desorption was performed using 0.5 M HCl (10 mL) as the stripping agent. Adsorbent weight (Right Y-axis) was lost after each cycle. FIG. 5e shows XRD analysis of P-laden unwashed CTL and P laden washed CTL. FIG. 5f shows phosphate desorption kinetics from washed CTL for 20 days. Equilibrium phosphate concentrations (Y-axis) were determined for pH 6.5, 7.0, and 7.5 DI water after 20 days (X-axis) (0.15 g of P-laden CTL where 17.3 mg of phosphate uptake occurred per g of CTL) was added into each pH level. FIG. 5g shows the final pH after each day vs. initial pH of DI water.

FIG. 6 shows XPS analysis of CTL before and after P removal. CTL HR C1s and O1S XPS spectra before (FIGS. 6a and 6b) and after (FIGS. 6c and 6d) P removal at pH 2.2. CTL HR Mg1s and Ca2p XPS spectra after (FIGS. 6e and 6f) P removal at pH 2.2.

FIG. 7 is a graphical representation of a process to prepare a CTL and its use in phosphate remediation, as described herein.

FIG. 8 shows an exemplary process for the preparation of modified biochar/coal according to the sixth aspect described herein.

FIG. 9 shows an exemplary sensor system for use in the processes described herein.

FIG. 10a shows an exemplary 24 hour production flow chart for the processes described herein.

FIG. 10b shows an exemplary apparatus for use in the processes described herein.

FIG. 11 shows an exemplary 24 hour production flow chart for the processes described herein.

### DETAILED DESCRIPTION OF THE INVENTION

As used herein the following definitions shall apply unless otherwise indicated.

As used herein, the term “thermally modified lignite” or “TL” refers to raw lignite that has been pyrolyzed, but not chemically treated (with, e.g., Mg²⁺ and Ca²⁺).

As used herein, the term “chemically and thermally modified lignite” or “CTL” refers to raw lignite that has been modified according to any of the processes described herein.

As used herein the terms “treating” refers to a reaction in which a raw lignite is surface modified with one or more specified ions via surface deposition.

### Composition and Textural Properties of Raw Lignite (RL), Thermally Modified Lignite (TL), and Chemically and Thermally Modified Lignite (CTL)

Coal surface area per unit weight depends on its source and rank and are typically approximately 100 m²/g for lignite (Mohan and Pittman, 2006). A very low lignite surface area (SBET, 1 m²/g) was also reported (Milicevic et al., 2012). Specific surface areas for RL, TL, and CTL were calculated through Brunauer-Emmett-Teller (BET) theory and are shown in Table 1. CO₂ and N₂ were employed as adsorbates for the BET surface area determinations. BET using N₂ can be inaccurate for samples with higher micropore contents (<1.2 nm) because the slow rate of N₂ diffusion blocks pore filling at 77K (de Jonge and Mittelmeijer-Hazeleger, 1996). In contrast, CO₂ fills micropores far faster because of its far higher thermal energy at 0° C. (McLaughlin, 2012). Specifically, the BET surface areas using N₂ were 2.9, 46, and 21 m²/g (Table 1) for RL, TL, and CTL, respectively (particle size, 150-300 μm) (Table 1). The corresponding surface areas using CO₂ were significantly larger (35, 127, and 120 m²/g for RL, TL, and CTL, respectively), indicating the abundance of narrow micropores in these samples.

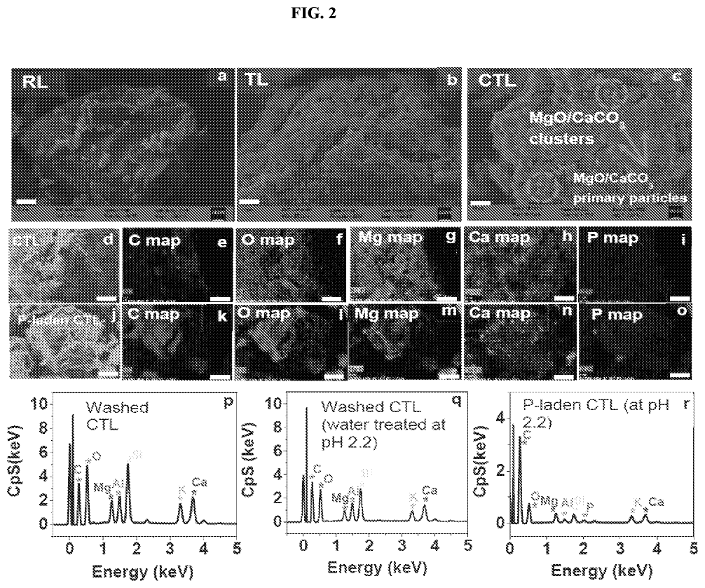

RL's low surface area (35 m²/g) increased to 127 m²/g in TL after heating at 600° C. under N₂. When the lignite is pyrolyzed, the moisture, volatiles and decomposing matter are evaporated. This out-gassing leads to new pore formation, or opening of closed pores, creating higher surface area materials. The average pore volume increased, and the average pore radius decreased slightly in TL versus RL (Table 1). A 40.5% weight loss occurred after RL's thermal treatment at 600° C. (yield of TL was 59.5%). The CTL surface area tripled versus RL (120 vs. 35 m²/g) due to fine MgO/Mg(OH)₂, CaO/Ca(OH)₂, and CaCO₃ particle formation, possibly due to loss of tightly held water and lignite structural changes. The oxides form the corresponding hydroxides on water washing. These surface deposits close some CTL pores, reducing total pore volume relative to TL. Mg/Ca compound existence on the CTL surface was observed from SEM/EDX observations (FIGS. 2d-2i), which increase the removal of phosphate. CTL's surface area, measured using CO₂, is slightly lower than TL (Table 1), which is consistent with the previous literature. The incorporation of MgCl₂ into wood biomass caused the micropores' blockage (MgO precipitation) and reduced the surface area by over one-third (Chen et al., 2020).

TABLE 1
Textural and Elemental Properties
of RL, TL, and CTL (washed form)

| | Absorbent | | |
|---|---|---|---|
| Parameter | RL | TL | CTL (washed forms) |

BET (m²/g)^{a} at the particle size 150-300 μm

| | | | |
|---|---|---|---|
| N² | 0.4 | 46.0 | 21.0 |
| CO₂ | 35 | 127 | 120 |
| qₑ (mg/g)^{b} at 25° C. | 2.4 | 0.6 | 11.6 |
| Sorption ability (mg/m²) | 6.0 | 0.01 | 0.6 |
| (N₂ BET) ^{c} | | | |
| Sorption ability (mg/m²) | 0.07 | 0.05 | 0.10 |
| (CO₂ BET) | | | |

Pore volume (cm³/g)

| | | | |
|---|---|---|---|
| N₂ | 0.0008 | 0.0109 | 0.0054 |
| CO₂ | 0.54 | 0.50 | 0.49 |

Micropore volume (cm³/g)

| | | | |
|---|---|---|---|
| N₂ | 2.9 | 2.3 | 1.7 |
| CO₂^{d} | N/A | N/A | N/A |

DFT pore size (nm)^{e}

| | | | |
|---|---|---|---|
| N₂ | 2.9 | 2.3 | 1.7 |
| CO₂ | 0.54 | 0.50 | 0.49 |
| Moisture (%) | 3.2 | 3.2 | 3.2 |
| C (%) | 39.4 | 26.5 | 13.5 |
| H (%) | 2.7 | 1.4 | 0.8 |
| N (%) | 1.2 | 1.4 | 0.9 |
| O^{f} (%) | 16.7 | 11.7 | 9.8 |
| Ash (%) | 25.0 | 59.0 | 75.0 |
| Point of Zero Charge (PZC) | 3.9 | 9.4 | 11.8 |
| Yield (%) | — | 59.5 | 38.7 |

^{a}Adsorbent surface areas were measured at the particle size 150-300 μm. When the particle size of all three adsorbents decreased to <150 μm, their BET surface areas (using N₂) increased (RL = 2.9 m²/g, TL = 120 m²/g, CTL = 60 m²/g).
^{b}RL, TL, and CTL uptake capacities (qₑ) at the particle size 150-300 μm were obtained
^{c} Phosphate removal capacity was divided by the absorbent surface area to obtain specific sorption ability (mg/m2).
^{d}Micropore volumes using CO₂ were negligible for all three adsorbents.
^{e}DFT theory accurately describes the pores in micro- and mesopore range.
^{f}O content presented here does not reflect the oxygen associated with their inorganic constituents.

Coals contain micropores (<1.2 nm), mesopores (1.2-30 nm), and macropores (>30 nm) (Simate et al., 2016). Pore sizes obtained from the NL-DFT method were presented in Table 1. DFT theory accurately describes the pores in the micro and mesopore range. NL-DFT treats the sample as an effective porous material, where heterogeneity is approximated by a distribution of pore sizes.

Thus, heterogeneity due to the chemical groups on the surface, pore shape variations, pore networking, and blocking effects is not accounted for explicitly (Fraissard and Conner, 1997; Inagaki, 2006). Pore size distributions of RL, TL, and CTL were obtained using both N₂-DFT and CO₂-DFT. RL has a wide pore size distribution (2-25 nm). TL has a higher mesopore fraction than RL, distributed from 1.8 to 2.3 nm by N₂-DFT. CTL is highly microporous, with pores narrowly distributed around 1.8.

CO₂-DFT found average pore diameters ranging from 0.49 to 0.54 nm for these three lignite adsorbents (Table 1). Phosphate anions have diameters of 0.223 nm, which increase to 0.339 nm with its water hydration shell (Zhong et al., 2015). Thus, a portion of micropores in all three adsorbents have access to hydrated phosphate.

The PZC of TL (˜9.4) versus RL (˜3.9) (Table 1) reflects the presence of basic oxides, hydroxides, and carbonates formed during the 600° C. lignite pyrolysis. The high TL porosity was caused by mass loss. The following extensive washings removed many basic oxides, hydroxides, and some carbonates from TL. The PZC of CTL increased to 11.8. The abundant silica was detected in both CTL and TL is from original lignite ash (19.9%, SiO₂), which is in good agreement with XRD analysis. Lignites are carbonaceous with 20-25% fixed carbon (Bowen and Irwin, 2008).

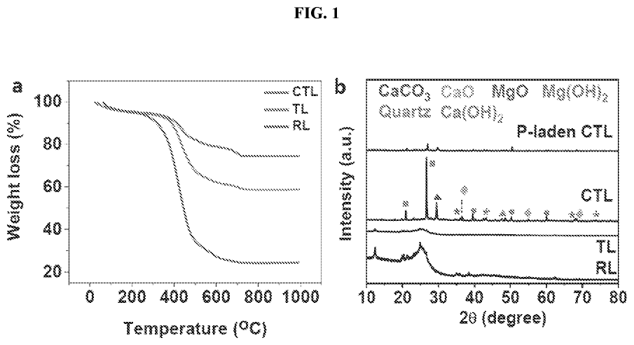

RL contains 39.4% C (Table 1). Heat treatment of RL reduced the C percentages remaining in TL (26.5%) (Table 1) while increasing the Al (0.3% to 2.3%) and Si (9.3% to 35.7%) contents in TL vs. RL. Organic matter gasification during thermolysis reduced carbon levels. The ash content of washed CTL (SiO₂, 54.4%, Al₂O₃, 12.1%, CaCO₃, 3.75%, and MgO, 4.8%) totals 75.0% (Table 1), is consistent with the ash content (˜74.6%) determined by TGA analysis run at 0-1000° C. under O₂ (heating rate 10° C./min) (FIG. 1a).

After complete acid digestion of washed CTL, Mg (2.9%) and Ca (1.5%) weight percentages were determined using atomic absorption spectroscopy (AAS). Bulk Ca and Mg percentages were smaller than the amounts detected using SEM/EDX studies (Mg=2.8% vs. Ca=5.9%), and the percentages quantified using XPS (Mg=12.4% and Ca=4.8%). Thus, Ca and Mg species are more concentrated on the top ˜8 nm of the CTL sample. After washing and drying, RL (1 atm, several days, 80° C.) and TL moisture contents were similar (˜3.2%) (Table 1). The inherent moisture of coal can be either the moisture within the micropores and microcapillaries while deposited in the ground (interior adsorbed water) or surface-bound water (Karthikeyan et al., 2009). CTL has a lower moisture content (˜2.5%) than TL and RL (˜3.2% in both) after heating the samples for 2 h in a hot air-oven at 105° C.

### XRD Analysis

The high background intensity in the RL XRD spectrum indicates an extensive amorphous carbon nature (FIG. 1b). The crystalline peaks at 2θ=24.9° (002) and 38.4° (100) depict the coal samples' aromatic stacking in some graphitic like carbon structures. The (002) peak's asymmetric nature is due to the association of a y peak from aliphatic side chains attached to the aromatic carbon (Zhao et al., 2020). CTL's XRD spectrum has many crystallite phases, in which the peaks are sharp, complicated, and highly ordered compared to RL (FIG. 1b). Specifically, sharp peaks located at 2θ=20.8° (“Quartz R100134—RRUFF Database,” 2020) and 26.6° correspond to the (100) and (011) reflection of quartz (SiO₂). Amorphous SiO₂ existed in RL, but after thermal treatment at 600° C. for 1 hour in the presence of Ca and Mg salts, sintering produces larger SiO₂ crystallites. These exhibit high-intensity peaks in XRD patterns (Buscarino et al., 2011). The intense peak at 2θ=29.4° is due to the CaCO₃ formed in the CTL, with an average CaCO₃ crystal size of 38.5 nm, determined by the Debye-Scherrer equation. This demonstrates the formation of nano-sized CaCO₃ grains on the CTL during the pyrolysis. Mg(OH)₂ and Ca(OH)₂ also formed and precipitated onto the CTL surface during synthesis when the pH rose using KOH. These hydroxides have lower solubility product constants than their sulfate precursors. Calcite was formed due to the inert pyrolytic atmosphere, where calcium hydroxide reacts with carbon dioxide produced from char particles during the pyrolysis process. Small amounts of Ca(OH)₂ (2θ=47.6° and 50.7°) and CaO (2θ=37.0°, 54.0°, and 67.0°) are present on the CTL surface (FIG. 1b). CaO peaks were less intense than Ca(OH)₂, indicating the surface exothermic (ΔH=−104 kJ/mol) hydration of CaO to Ca(OH)₂ occurred (Criado et al., 2014). Residual CaO/Ca(OH)₂, MgO/Mg(OH)₂, K₂O, KOH, and K₂CO₃ on the CTL surface and encapsulated onto some pores was removed during the washing step after the pyrolysis. In this wash, the initial 89.0 g mass was reduced by 35.1 g leaving 53.9 g afterwards.

Other CTL peaks at 21.2°, 39.7°, 50.5°, and 60.0° accredited to Mg(OH)₂ (Zhang et al., 2015). The peaks at 2θ=36.6°, 43.4°, 62.6°, and 74.7° can be indexed to the 111, 200, 220, and 311 planes of face-centered cubic surface MgO. The tiny 43.3° peak indicated traces of MgO (˜50.5 nm) exist on the CTL. MgO formation on the CTL is caused by the dehydration of Mg(OH)₂ (ΔH=+81 J/mol) (Mastronardo et al., 2016). If MgSO₄ was present, it could decompose to MgO under the reducing atmosphere.

After P removal at pH 2.2, peaks located at 2θ=29.8° and 39.7° (CaCO₃ and Mg(OH)₂) suffered significant intensity reduction, and the peaks centered at 60° and 36°-37° (Mg(OH)₂) and 47°-48° (Ca(OH)₂) vanished in P-laden CTL (FIG. 1b). Dissolution of CaCO₃, Mg(OH)₂, and Ca(OH)₂ in an acidic medium form soluble Ca²⁺/Mg²⁺, which reacts with phosphate anions in solution and forms corresponding insoluble phosphates and hydrophosphates in the CTL. This reduced the CaCO₃ and Mg(OH)₂ peak intensities (FIG. 1b). The new XRD peaks in P-laden CTL (FIG. 1b) were assigned to MgHPO₄·1.2H₂O, Mg₃(PO₄)2·8H₂O, CaHPO₄ and Ca₃(PO₄)₂ (Hung et al., 2012; Zhang et al., 2016). No Ca(OH)₂ is retained in CTL at pH=2.2 (Ksp=5.5×10⁻⁶). The hydroxyapatite (Ca₅(PO₄)₃(OH)) diffraction pattern was not observed in the P-laden XRD spectrum. Next, when CTL was exposed to 1000 ppm phosphate solution (pH 2.2) at 25° C., the pH increased to ˜10.0 immediately. At this pH, phosphates mainly exist as HPO₄²⁻/PO₄³⁻. The Ca(OH)₂ released under acidic conditions precipitated as brushite (CaHPO₄). Brushite is the most thermodynamically stable phase relative to other calcium compounds at room temperature in the lower pH region. Here, Ca²⁺ reacts with H₂PO₄⁻ producing brushite, as demonstrated by XRD (Wuthier et al., 1985). Previously, brushite was formed on P-laden Ca-doped biochar (˜20 wt. % Ca(OH)₂/biochar) at pH=2 (Antunes et al., 2018). CaCO₃, the major phase retained in the CTL surface, is insoluble (Ksp=2.9×10-9). However, it releases dissolved Ca2+ at pH 2.2, which forms a surface CaHPO₄ precipitate.

### Adsorbent Morphologies

### SEM, SEM-EDX, and TEM Analysis of Adsorbents

Scanning electron microscopy (SEM) analyses examined the morphology and chemistry changes after thermal and chemical modifications to RL (FIG. 2). RL's relatively smooth surface morphology became more irregular in TL and washed CTL (FIG. 2a). TL contained many micron-sized pores (FIG. 2b, marked with arrows). Most surface particles deposited on CTL are agglomerated and roughen the surface (FIG. 2c). Scanning electron microscopy with energy dispersive X-ray (SEM/EDX) mapping of CTL (FIGS. 2d-2h) displayed Mg, Ca, C, and O that are distributed in overlapped regions, in accordance with MgCO₃, CaCO₃, MgO, Mg(OH)₂, and Ca(OH)₂ present on the surface. These particle size diameters were mostly below 2 μm (FIG. 2c). Chemical impregnation and subsequent thermal conversion at 600° C. deposits Ca and Mg minerals onto CTL, appearing as lightly shaded primary particles and/or aggregated clusters (FIG. 2c).

RL exhibits abundant C, O, with Al, Si, Mg, Ca, K, and Fe in the surface region. SEM-EDX analysis of CTL after exposure to pH=2.2 DI water (25 mL, 200 rpm, 24 h, 25° C.), filtering and drying showed smaller Ca, Mg, Si, K, and O atomic percentages (FIGS. 2p and 2q) compared to before washing. Also, pH increased from pH=2.2 to pH 9.3, and a 30% CTL weight loss occurred. Acidic rinsing dissolved many mineral oxides from the surface and caused the EDS peak reductions. The obvious loss of basic Mg and Ca compounds took place from CTL under acidic conditions. The Mg²⁺ and Ca²⁺ ions released then reacted to form insoluble phosphates, which precipitated and were observed in the P-laden CTL EDX spectrum (FIG. 2r). Ca and Mg compounds retained in unwashed CTL exhibited more phosphate removal than washed CTL (80.6 mg/g vs. 15.5 mg/g).

FIGS. 2j-2o show the washed CTL SEM/EDX analysis after exposure to 100 ppm phosphate solution (labeled P-laden CTL). After phosphate uptake, Ca dropped from 5.9% to 1.5% and Mg dropped from 2.8% to 1.3% atomic percentages on the P-laden CTL surface. P-laden CTL EDX elemental mapping found that phosphorus was concentrated in the regions where Ca, Mg, and O had deposited (FIGS. 2l-2o). Mg₃(PO₄)₂, MgHPO₄, and CaHPO₄ were precipitated on CTL at pH 2.2 during this P uptake, according to XRD/XPS studies. This occurred because both Ca²⁺ and Mg²⁺ dissolved into water, where it reacted with HPO₄²⁻/P₄³⁻. Previous studies found that phosphate uptake also occurs by surface deposition (Yao et al., 2011). The EDX electron spectrum found 3.5 wt. % P in P-laden CTL (FIG. 2r). This contrasts sharply with P-laden RL (0.8 wt. % P) and P-laden TL (1.3 wt. % P). The CTL vs RL wt. % of Mg (2.8% vs 0%) and Ca (5.9% vs. 0.02%) favor phosphate uptake by CTL. This confirms the combined chemical and thermal modification process using Mg and Ca enhances lignite's use for phosphate remediation. Nevertheless, RL can be used alone without expending any process modification costs to adsorb phosphate.

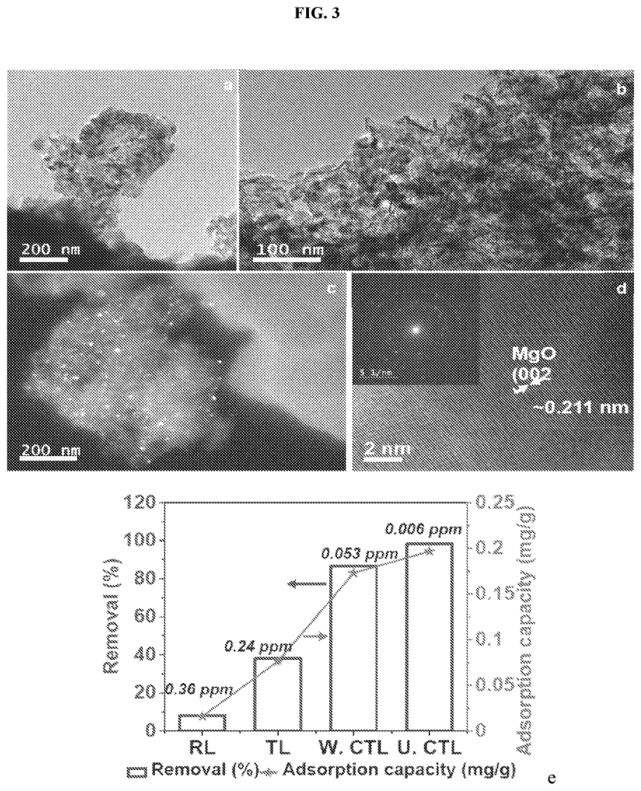

Tunneling electron microscopy (TEM) images of CTL showed MgO clusters (black) dispersed on the char matrix (grey) (FIG. 3a). The flake-like morphology of MgO at a higher resolution (FIG. 3b) displayed tiny MgO crystallites (size 20-30 nm) aggregated to larger MgO cluster sizes between 200 nm to 2 μm. The dark field image of CTL showed the MgO clusters (white) in a dark background (char matrix) (FIG. 3c). These MgO clusters were confirmed by acquiring the sample's SAED pattern (FIG. 3d), with a d spacing of 0.211 nm. This d spacing belonged to MgO-002 crystal phase according to the crystal structure database. CaO hydration is an exothermic (ΔH=−104 kJ/mol) and a spontaneous process (Criado et al., 2014). However, precipitated Ca(OH)₂ has a high solubility product, and it is hard to observe on CTL after washing. Low hydration of MgO was reported (ΔH=+81 kJ/mol) (Dung and Unluer, 2017; Mastronardo et al., 2016), making it comparatively more stable than CaO on the CTL.

### Adsorption Performance

### Effects of Low Initial Phosphate Concentration, Adsorbent Particle Size and Adsorption Kinetics

Efficient sorbents have a high adsorbate affinity at low adsorbate concentrations (Wu et al., 2020). Sorption affinities of RL, TL, washed CTL, and unwashed CTL were tested at low phosphate concentration (0.4 ppm) (FIG. 3e). The unwashed CTL afforded more than 98% of phosphate removal versus RL (8%), TL (38%), and washed CTL (86%), making it a promising selective phosphate adsorbent. Unwashed CTL achieved ultra-low equilibrium phosphate concentration (0.006 ppm) at an initial phosphate conc. of 0.4 ppm. This value is below USEPA's suggested phosphate level in water, 0.01 ppm to prevent possibility of eutrophication (US EPA, 2018).

When the particle size decreased from >300 to <150 μm, phosphate adsorption increased by 37% (RL), 80% (TL), and 33% (CTL) (adsorbent dose 50 mg, 25 mL of 50 ppm [phosphate], 24 h, pH 5.5, 25° C.). The <150 μm particle size had a higher phosphate removal and was selected for adsorption isotherm experiments. Interestingly, RL surfaces have a higher specific sorption ability per unit surface area (6.0 mg/m²) than CTL (0.6 mg/m²) and TL (0.01 mg/m²) (adsorbent dose 50 mg, 25 mL of 50 ppm [phosphate], 24 h, pH 2.2, 25° C., particle size, 150-300 μm) (Table 1). When RL was ground to smaller particle size, <150 μm RL's sorption ability was lower (1.0 mg/m²). This is due to the increase of its surface area (2.9 m²/g) at the size <150 μm. RL can be used for water treatment with lower production costs than CTL, as it requires no pre-treatment, and is plentiful and cheap. CTL's higher capacity (11.6 mg/g) (Table 1) is due to the dissolution of Ca²⁺ and Mg²⁺ ions, which precipitates its phosphate and hydrophosphate salts.

The CTL P uptake initially increased rapidly, and >80% of the maximum adsorption capacity (17.9 mg/g) was adsorbed within 5 h (adsorbent dose 50 mg, 25 mL solution volume, 50 ppm phosphate concentration, 25° C.). This rise was due to the presence of un-occupied adsorption sites on the CTL surface at the beginning. However, CTL P removal equilibrium was achieved after ˜20 h, similar to phosphate adsorption into MgO-digested sugar beet tailings biochar (Yao et al., 2011) and Mg-enriched tomato tissue biochar (Yao et al., 2013). Rapid initial and slow subsequent uptake suggest that precipitation is not the only removal path. The reported abundant nano-CaO and MgO (PZC>10) surface species and a very high BET specific surface area of Ca—Mg/biochar (487.5 m²/g) accelerated the P binding equilibrium to within 30 min. (Fang et al., 2015). The slow P removal kinetics by washed CTL can be due to the much smaller quantities of MgO and Mg(OH)₂ (after washing), which reduces the amount and rate of phosphate uptake by precipitation and adsorption. The relatively low CTL surface area (BET-N2, 21 m²/g and BET-CO₂, 120 m²/g) reduces the extent of physisorption. The calculated qₑ of CTL (18.9 mg/g) is close to the experimental value (17.9 mg/g). CTL phosphate removal follows the pseudo-second-order kinetic model (R2=0.99), suggesting chemical bond formation. Similar trends were observed in Ca-doped biochar (Antunes et al., 2018) and MgO-modified diatomite (Xie et al., 2014). Phosphate binding onto Mg-enriched tomato tissue could be better described by an n^{th} order model and followed multiple mechanisms (Yao et al., 2013).

Phosphate adsorption into TL (k2=0.3 g/mg min) is faster than CTL (k2=0.04 g/mg min). As the contact time increases, TL's kinetic curve exhibited a rapid phosphate uptake and plateaued ˜5 h, with a maximum phosphate absorbance of 1.9 mg/g. Pseudo-second-order kinetic model describes TL phosphate removal well.

### pH Dependence of P Adsorption

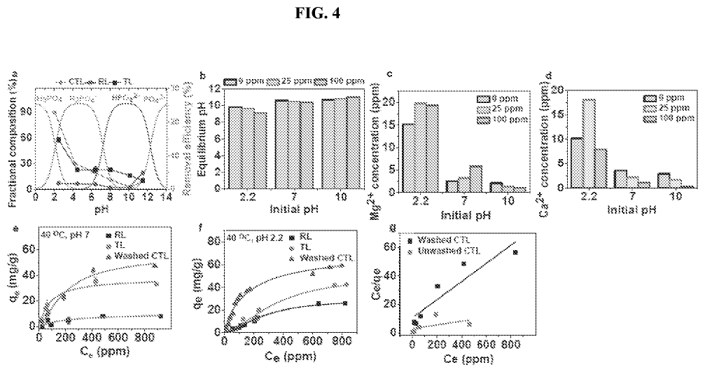

Phosphate sorption by RL is only weakly pH-dependent (FIG. 4a). At approximately pH 2.2, phosphate sorption was highest on washed CTL (22.9%) versus TL (14.7%) and RL (1.7%) (adsorbent dose 50 mg, 25 mL of 50 ppm phosphate concentration, 24 h, particle size 150-300 μm, 25° C.). The CTL and TL (PZCs, 11.8, and 9.4) were positively charged under typical wastewater pH conditions (pH=6-9); therefore, they can be successfully employed in phosphate removal from acidic wastewaters (mining wastewater, acidic leachates from wet chemical P-recovery process). Both CTL and TL (Table 1) demonstrated higher phosphate uptake per unit weight than RL due to their more basic PZC (FIG. 4a) and higher surface areas. Removal efficiency changes occur with surface property alterations and phosphate speciation. H₃PO₄ exhibits pKₐ₁=2.12, pKₐ₂=7.21 and pKₐ₃=12.67 and its aqueous speciation is shown in FIG. 4a. When the initial pH is ˜2-3 (but with a highly alkaline final equilibrium pH ˜9.4), positive sites on the CTL and TL surfaces can attract HPO₄²⁻/PO₄³⁻ adsorption. In an earlier study, phosphate anion adsorption was favorable when the solution pH was below the PZC of a Fe—Al—Mn tri-metal oxide (˜9.0) (Lu et al., 2013).

Leaching of Mg²⁺ and Ca²⁺ from washed CTL was investigated at pH 2.2, 7, and 10 in the presence/absence of dissolved phosphate (0, 25, and 100 ppm) (25 mL solution volume, 25° C.). After reaching equilibrium with either phosphate-containing or phosphate-free solutions, the final pHs had risen (FIG. 4b). The average final pH values were 9.4, 10.5, and 10.8 versus initial pH 2.2, 7, and 10 values, respectively. Surface deposited Mg(OH)₂, MgO, Ca(OH)₂, and CaCO₃ were identified on the CTL during XRD/XPS/EDX analysis. Ca²⁺ leaching from CaCO₃ dissolution in the CTL was negligible at pH 7 because of its lower solubility (Ksp=2.9×10⁻⁹) versus Ca(OH)₂ (Ksp=5.5×10⁻⁶). At pH 7, Ca(OH)₂ has a higher solubility than Mg(OH)₂ (Ksp=5.61×10-¹²). This caused higher Ca²⁺ leaching (3.5 mg/L) than Mg²⁺ (2.6 mg/L) leaching in the absence of phosphates (FIGS. 4c and 4d). These discharges were most pronounced at the initial pH 2.2. Dissolution of basic surface oxides/hydroxides (Mg(OH)₂, MgO, CaCO₃, and Ca(OH)₂) caused the equilibrium pH to rise. More dissolved Mg²⁺ and Ca²⁺ (15.2 ppm and 10 ppm) were detected when the initial solution pH=2.2 than in solutions with an initial pH 7 (2.6 ppm and 3.5 ppm) or 10 (2.1 ppm and 2.9 ppm) in phosphate-free solutions (FIGS. 4c and 4d). These pH values were time-dependent as pH changes with the adsorption of phosphate.

In the presence of the dissolved phosphates, pollutant species (speciation quantities which depend on the pH), Mg₃(PO₄)₂, CaHPO₄, MgHPO₄, and Ca₃(PO₄)₂ were deposited onto the CTL, as demonstrated by XRD/XPS analysis. When the phosphate concentration rose to 25 ppm, Ca²⁺ precipitates as less soluble Ca₃(PO₄)₂ (Ksp=2.1×10⁻³³), giving less measured Ca²⁺ leaching (2.2 mg/L) at pH 7 (FIG. 4d). Precipitated Mg₃(PO₄)₂ (Ksp=1.0×10⁻²⁴) from Mg²⁺ leaching is somewhat more soluble than Ca₃(PO₄)₂. Therefore, it leads to observing a slightly higher Mg²⁺ leaching mount (3.2 mg/L) than Ca²⁺ (FIGS. 4c and 4d). Further increasing the phosphate concentration to 100 ppm released more Mg²⁺ (5.8 mg/L) from deposited Mg₃(PO₄)₂, whereas further dropping the amount of Ca²⁺ leaching (FIGS. 4c and 4d). Reduced Mg²⁺ and Ca²⁺ leaching at pH 7 is attributed at least in part to the low CTL Langmuir adsorption capacity at pH 7 (see section 3.4.3). Leaching of Mg²⁺ and Ca²⁺ from sorbents under acidic conditions was previously reported (Lim and Kim, 2017).

Partial dissolution of Mg(OH)₂, MgO, Ca(OH)₂, and CaCO₃ sites on the CTL surface is followed by precipitation of Ca²⁺ and Mg²⁺ phosphates/hydrophosphates and sorption occurs at protonated surfaces which attract HPO₄²⁻/PO₄³⁻. This gives high CTL P removal efficiency (19.9%) at pH=2.2 (FIG. 4a). A control experiment conducted using acidic water (phosphate-free) at pH=2.2, and 36% of the Mg and 72% of the Ca originally on CTL were leached into DI water. Therefore, precipitation-controlled P removal is also possible with CTL under an acidic pH. As the pH level increases, the CTL's P removal efficiency significantly decreased from 19.9% (pH=2.2) to 0.3% (pH=10). Several reasons may govern this decline of P uptake. CTL's surface positive charge drops at high pH, which reduces the phosphate anion adsorption. High solution pH generates columbic repulsion between the deprotonated surface Mg(OH)₂/MgO sites and HPO₄²⁻/PO₄³⁻, lowering phosphate uptake. Lower amounts of Ca²⁺ and Mg²⁺ were released from CTL at high pH (FIGS. 4c and 4d), therefore, phosphate precipitation declines. High Ca quantities can immobilize phosphate (Chen et al., 2007).

At low pH (approximately 2), TL has greater phosphate adsorption than RL, due to the higher Al (0.9% vs 0.3%) and Mg contents (0.5% vs. 0.3%), and higher surface area. Al content on biochar improved phosphate adsorption (Yin et al., 2018). Lower surface area and a surface-cation-deficiency account for the lower P-binding of RL. A mild increase in RL adsorption at pH 11.5 may be caused by some surface OH groups ion exchanging with phosphate ions.

### Adsorption Isotherms and Thermodynamics

Isotherm studies were conducted at the optimal pH (pH 2.2) and the environmentally relevant pH level (pH 7) (FIGS. 4e and 4f). Washed CTL exhibited a higher maximum Sips P uptake capacity (74 mg/g) than RL (35 mg/g) and TL (50 mg/g) at 40° C. using 1000 ppm initial phosphate level (adsorbent dose 50 mg, 24 h, pH 2.2, particle size <150 μm) (FIG. 4e). Langmuir, Freundlich, and Sips isotherm model fitted parameters were determined. Regression coefficients were obtained for Langmuir (0.57-0.99), Freundlich (0.89-0.99), and Sips (0.98-1.00). The Sips model better describes phosphate removal by RL, TL, and washed CTL. All three of these phosphate removals are combined Langmuir-Freundlich processes, consistent with previous findings (Yao et al., 2013). The specific sorption per unit surface area of RL was greater (12.1 mg/m²) than those of TL (0.4 mg/m²) and washed CTL (1.2 mg/m²) (40° C., pH 2.2, particle size, particle size <150 μm). The BET surface areas of RL, TL, and CTL at the particle size <150 μm were 2.9 m²/g, 120 m²/g, and 60 m²/g, respectively.

The isotherm studies were conducted for pyrolyzed and washed CTL, and pyrolyzed but unwashed CTL at pH 7, 25° C. (FIG. 4g). The washed CTL exhibited a maximum Langmuir phosphate removal capacity of 15.5 mg/g (Table 2) versus TL (2.5 mg/g) and RL (1.1 mg/g) (pH 7, particle size <150 μm, adsorbent dose 50 mg, 25 mL of 25-1000 ppm phosphate concentration, 24 h). Maximum Langmuir phosphate removal capacity of the unwashed CTL sample after pyrolysis at 600° C. (80.6 mg/g) (Table 2) was five times higher than that of washed CTL sample (15.5 mg/g) because far more CaO/Ca(OH)₂, MgO/Mg(OH)₂ and K₂CO₃ remained on the surface. The uptake capacities obtained at 25° C. and pH 7 (CTL, 15.5 mg/g, TL, 2.5 mg/g, and RL, 1.1 mg/g) are lower than the uptake capacities obtained at 25° C., pH 2.2 (CTL, 24.8 mg/g, TL, 13.2 mg/g, and RL, 5.2 mg/g) due to the greater Ca²⁺/Mg²⁺ dissolution from CTL at the more acidic pH which lows more HPO₄²⁻/PO₄³⁻ to precipitate as Ca²⁺/Mg²⁺ salts. Declining electrostatic attraction of HPO₄²⁻/PO₄³⁻ with MgO/Mg(OH)₂ on CTL (PZC=13) is also occurring at pH 7 compared to pH 2.2. Maximum phosphate sorption capacities of CTL (washed/unwashed) were compared with the previously developed adsorbents (Table 2).

TABLE 2
Phosphate Removal using Different Mg and Ca-Modified Adsorbents

| | Initial (Mg/Ca | | Adsorption | |
|---|---|---|---|---|
| | compound:adsorbent) | | capacity | |
| Adsorbent | mass ratio | Experimental Conditions | (mg/g) | Reference |
| Magnesium oxide | 3:5 (as | PO₄³⁻(100 mL), 4-50 | 45.7 | (Xie et al., 2014) |
| nanoflake-modified | MgCl₂•6H₂O) | mg/L, pH 5.0, MOD (50 | | |
| diatomite adsorbent | | mg), 12 h, 25° C. | | |
| (MOD) | | | | |
| Calcium decorated | 2:1, 1:1 (as CaCO₃) | Adsorbent dosage 3 g/L. | 116.8 | (Kong et al., |
| sludge carbon (Ca- | | 200-1000 mg/L | | 2018) |
| SC) | | [Phosphate], 25° C. | | |
| Sugarcane bagasse | 1:1 (MgCl₂•6H₂O | 3-5800 mg/L [PO₄³⁻], pH | 129.8 | (Fang et al., 2020) |
| biochar | and CaCl₂•2H₂O) | 2, 5, 10, 20, 40, 60, 80, | | |
| | | 120, 240, 360, and 720 | | |
| | | min, 25° C. | | |
| Mg(OH)₂/ZrO₂ | 6:5 (MgCl₂•6H₂O | pH 7, 15 mg of adsorbent, | 87.2 (PO₄) | (Lin et al., 2019) |
| composite (MZ) | and ZrOCl₂•8H₂O) | 50 mL solution volume, 5 | | |
| | | to 50 mg PO₄/L, 24 h, | | |
| | | 25° C. | | |
| Washed CTL | 1:10 (as MgSO₄) | 1-1000 ppm, 40° C., pH | 74 | The present |
| | 1:10 (as CaSO₄) | 2.2, 25 mL solution | | disclosure |
| | | volume, and 0.05 g of | | |
| | | CTL | | |
| Washed CTL | 1:10 (as MgSO₄) | 1-1000 ppm, 25° C., pH 7, | 15.5 | The present |
| | 1:10 (as CaSO₄) | 25 mL solution volume, | | disclosure |
| | | and 0.05 g of CTL | | |
| Unwashed CTL | 1:10 (as MgSO₄) | 1-1000 ppm, 25° C., pH 7, | 80.6 | The present |
| | 1:10 (as CaSO₄) | 25 mL solution volume, | | disclosure |
| | | and 0.05 g of CTL | | |
| Unwashed CTL | 1:10 (as MgSO₄) | 1-1000 ppm, 40° C., pH 7, | 378.2 | The present |
| | 1:10 (as CaSO₄) | 25 mL solution volume, | | disclosure |
| | | and 0.05 g of CTL | | |

Thermodynamic parameters (ΔG, ΔH, and ΔS) were calculated for all isothermal studies performed at pH 2.2. Phosphate sorption was spontaneous on RL, TL, and washed CTL (negative ΔG values) and all ΔH values were endothermic (positive). ΔH values were RL (308.9 kJ/mol) TL (241.5 kJ/mol), and washed CTL (100.4 kJ/mol) were consistent with chemisorption (greater than 40 kJ/mol) and not physisorption (less than 20 kJ/mol). This is consistent with the kinetic analysis. Positive values of ΔS (RL [1.11], TL [0.91], and washed CTL [0.43] kJ/mol) revealed increased randomness in the uptake processes.

### Reuse, Regeneration and Phosphate Leaching by CTL

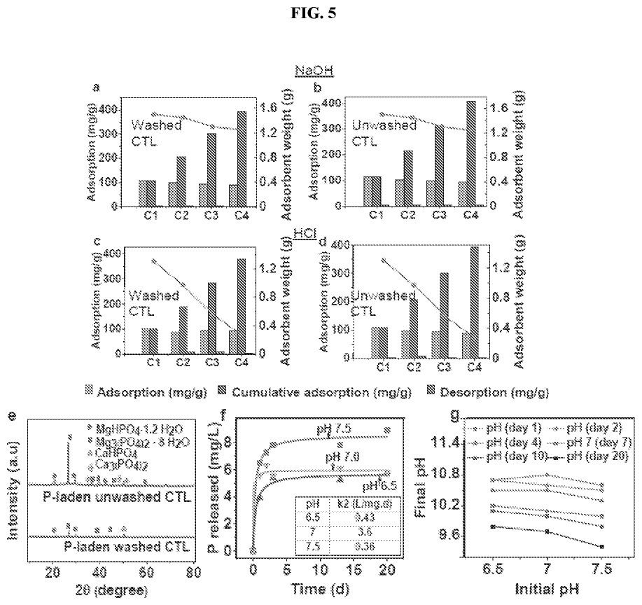

Washed and unwashed CTLs' recycling and use as a fertilizer was investigated after adsorbing phosphates. The phosphate adsorption-desorption was studied under 1000 ppm phosphate solution and 1.5 g of CTL dose, at pH 7, 25° C. (FIGS. 5a and 5b). P-loaded CTL was desorbed with a 1 M NaOH stripping agent. Both the adsorption amount in each cycle (mg/g) and the cumulative amount of removed (mg/g) are presented. Washed CTL's P uptake decreased slightly more in the second cycle (98.3 mg/g) over the first cycle (108.0 mg/g) and decreased slightly in the third and fourth (94.7 and 90.0 mg/g) (FIG. 5a). About 113.0 mg/g of Phosphate adsorbed on unwashed CTL in the first cycle (FIG. 5b). This amount sharply dropped to (102.2, 98.9, and 94.7 mg/g) in the second, third and fourth cycles. However, only a very small fraction of the adsorbed or precipitated phosphates on both CTLs were desorbed in each cycle. While only these cycles were run, continued phosphate uptake would likely continue until no more Ca²⁺ or Mg²⁺ could leach from CTLs into the solution to precipitate phosphates. Stable MgHPO₄, Mg₃(PO₄)₂, CaHPO₄, and Ca₃(PO₄)₂ formation on CTLs and diffusion of phosphate moieties to CTLs pores may eventually cover leachable Ca²⁺ and Mg²⁺ oxides and hydroxides (Kajjumba et al., 2019). Desorption capacities were found by multiplying the equilibrium phosphate concentration by the stripping agent's volume and dividing it by the adsorbent weight. The P-laden washed CTL's desorption (mg/g) decreased each successive cycle (4.7 mg/g in cycle 1, 4.6 mg/g in cycle 2, 4.2 mg/g in cycle 3, and 4.0 mg/g in cycle 4) slightly. 1 M NaOH is not a suitable phosphate stripper for phosphate because the precipitated Mg and Ca phosphates/hydrophosphates have very low solubilities in aqueous NaOH (Sugiyama et al., 2005). The inner-sphere complexation (ligand exchange) of surface R—OH (R=mineral or carbonaceous) sites for phosphate oxygen atoms to chemisorb as R—O—PO₃³⁻ (or its hydrogen phosphate analogs) is not the dominant mechanism of CTL's phosphate removal. Thus, basic stripping was unable to succeed in phosphate recovery (Wu et al., 2020). A 20 w/v % NaOH solution desorbed 80% phosphate from exhausted synthetic hydrocalcite, in which the reversible ion exchange is one of the major mechanisms (Kuzawa et al., 2006).

XRD patterns of P-laden unwashed CTL and washed CTL illustrate the crystallographic structures formed upon P uptake (FIG. 5e). In both spectra, calcium phosphates/hydrophosphates peak intensities are lower than the magnesium phosphates/hydrophosphates. This could be because CaHPO₄ (Kₛₚ, 1.3×10-7) is more highly soluble than Mg₃(PO₄)₂ (Kₛₚ, 1.0×10⁻²4) in aqueous solutions. This led to more Ca²⁺ in the solution than Mg²⁺ (Antunes et al., 2018). Stable MgHPO₄ and Mg₃(PO₄)₂ crystals are harder to desorb using 1 M NaOH. Very low (˜3.8%) phosphate desorbability from Mg(OH)₂ abundant diatomite was reported in 1 mmol NaOH solution (Xie et al., 2014). A classic stripping process would need to efficiently dissolve the surface Mg₃(PO₄)₂, CaHPO₄, MgHPO₄ and Ca₃(PO₄)₂ salts deposited on CTL.

Batch desorptions were carried out by stirring the P-laden washed CTL and P-laden unwashed CTL with 10 mL of 0.5 M HCl. The amount desorbed by 0.5 M HCl from the washed CTL was 0 mg/g in the first cycle because phosphate precipitation as Ca²⁺/Mg²⁺ salts is more referable at acidic pH (FIG. 5c). The underlying Ca²⁺/Mg²⁺ basic species leach into the solution, where they immediately reprecipitate as insoluble phosphates/hydrogen phosphates. More Ca²⁺/Mg²⁺ leach from hydroxides, oxides, carbonates at pH 2.2, forming more phosphate and hydrophosphate salts precipitate back on the surface. Succeeding stripping cycles remove more phosphorus from the sorbent because less Ca²⁺/Mg²⁺ species can strip from the dwindling supply of basic compounds on the surface. This causes the pH near the surface to drop and the water-insoluble phosphate and hydrogen phosphate precipitates can now dissolve in the acidic stripper solution near the surface. Phosphate adsorption onto washed CTL in the second cycle (87.6 mg/g) was lower than the first cycle (112.2 mg/g) because the sorbent active sites were mostly occupied by phosphates on the first cycle. Phosphates were desorbed (10.8 mg/g) in the second cycle (FIG. 5c), as the stronger acid (lower pH near the surface) could dissolve Mg and Ca phosphates/hydrophosphate. Each cycle might also dissolve some of the Mg²⁺ and Ca²⁺ basic compounds originally deposited on washed CTL which might eventually deplete the original stoichiometric capability of washed CTL to precipitate insoluble phosphate salts on the CTL. Acidic desorption was employed by Li et al., 2016a and Zhang et al., 2019. Ca-bound P in earlier work was extracted using HCl (Mitrogiannis et al., 2017). Phosphate desorption from washed CTL decreased to 2 mg/g in the fourth cycle, without affecting the subsequent phosphate sorption performance. Desorptions (mg/g) obtained for washed CTL in HCl on two through four cycles (10.8 mg/g, 11.1 mg/g, and 2.5 mg/g) are higher than in NaOH on cycles 1-4 (4.7 mg/g, 4.6 mg/g, 4.2 mg/g, and 4.0 mg/g) (FIGS. 5a and 5c). The adsorbent weight decreased after each cycle due to the dissolution of precipitated phosphate salts by HCl or weight loss caused by the filtering process after each cycle (FIG. 5c). This reduces the ability to use several adsorption/desorption cycles. This is not classic adsorption/desorption. These are stoichiometric dissolutions of Ca(OH)₂, CaCO₃, MgO, and Mg(OH)₂ with reprecipitation of Mg₃(PO₄)₂, MgHPO₄, Ca₃(PO₄)₂, and CaHPO₄, all occurring in competition as a function of the surrounding pH.

Phosphate uptake of unwashed CTL (108.8, 98.3, 96.7, and 92.0 mg/g) is far better than the washed CTL (102.2, 87.6, 94.9, and 90.0 mg/g) on four regeneration cycles (FIGS. 5c and 5d). P-laden unwashed CTL has greater quantities of Mg₃(PO₄)₂, MgHPO₄, Ca₃(PO₄)₂, and CaHPO₄ than P-laden washed CTL (FIG. 5e), which can be attributed to its higher phosphate uptake. Furthermore, larger phosphate cumulative capacity was observed in unwashed CTL (391.8 mg/g) than washed CTL (374.7 mg/g) after four cycles. Therefore, exhausted unwashed CTL potentially improves soil fertility as it retained more phosphates. Higher desorption from P-laden unwashed CTL (3.1 mg/g) than from P-laden washed CTL (0 mg/g) was recorded in the first cycle. Low Ca/Mg phosphates/hydrophosphate quantities precipitated on P-laden washed CTL (FIG. 5b) could be more easily desorbed in HCl than unwashed CTL. The desorbed P from the exhausted washed CTL (˜29000 mg P kg⁻¹) and unwashed CTL (˜19100 mg P kg⁻¹) for 4 cycles are much higher than the level of soil P requirement, i.e., 45-50 mg P kg⁻¹.

Phosphate desorption kinetics of P-laden washed CTL was investigated at different pH levels (6.5, 7.0, and 7.5) using deionized water, and the data were fitted using a second-order kinetic model (FIG. 5f). Initially, phosphates were adsorbed onto the 0.45 g of the adsorbent used to follow desorption using 300 mL of 100 ppm PO43- at pH 7. The phosphate uptake was 52 mg/g (under these conditions, washed CTL does not meet a saturation as the supply of solute concentration is inadequate for a large dose of the adsorbent). This P-laden material was divided equally into three portions and treated with different DI water (pH=6.5, 7.0, and 7.5) solutions. The desorption of phosphates from these samples is shown in FIG. 5f. At all pH levels, the phosphate released rate is initially high before reaching equilibrium after 1-4 d (however, initial pH levels can be confusing since the pH became much more basic or contradict with the P-laden samples due to further basic Ca²⁺/Mg²⁺ compounds remaining on their surfaces). Equilibrium released rates were 8 mg/L P at initial pH 7.5 (t=4 d), 5.9 mg/L at initial pH 7 (t=2.5 d), and 4 mg/L at initial pH 6.5 (t=1 d). Therefore, washed CTL behaves as a slow-release fertilizer under different pH conditions. Slow-release fertilizers are beneficial because their nutrients are released slowly, avoiding the need for frequent soil applications.

At low pH, Ca/Mg phosphates tend to precipitate and becomes unavailable to plants. When the initial pH rose from pH 6.5 to 7.5, the equilibrium P concentrations in DI water also rose after 20 days where the final pH values were, 9.8, 9.7, and 9.4, respectively (FIG. 5f). The highest leached P concentration (8.9 mg/L) was found at pH=7.5 after 20 days. The P adsorption affinity of washed CTL decreases as pH increases because the competition between phosphates and hydroxide ions is high. After day three, solutions with initial pH=7 and 6.5 exhibited constant phosphate concentrations. After adding P-laden adsorbents, all solution pH values were initially greater than 10 before decreasing with time (FIG. 5g). P-loaded CTL (initial concentration, 100 ppm) underwent 52.9% (initial pH=6.5), 51.7% (initial pH=7), and 57.4% (initial pH=7.5) PO₄³⁻ leaching within a 20-d period.

### XPS Analysis and CTL Phosphate Binding Interactions

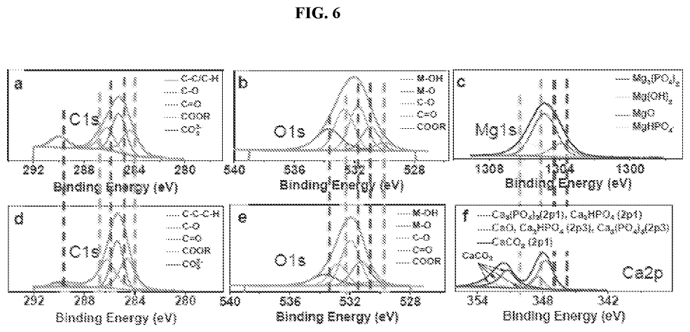

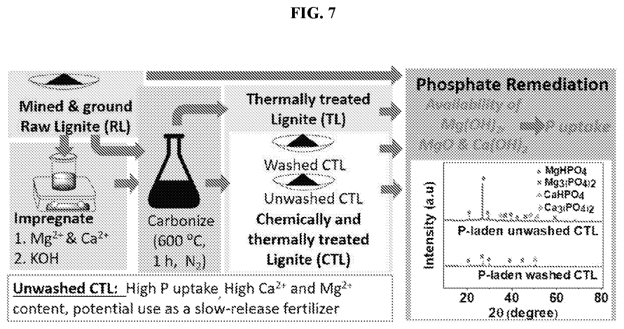

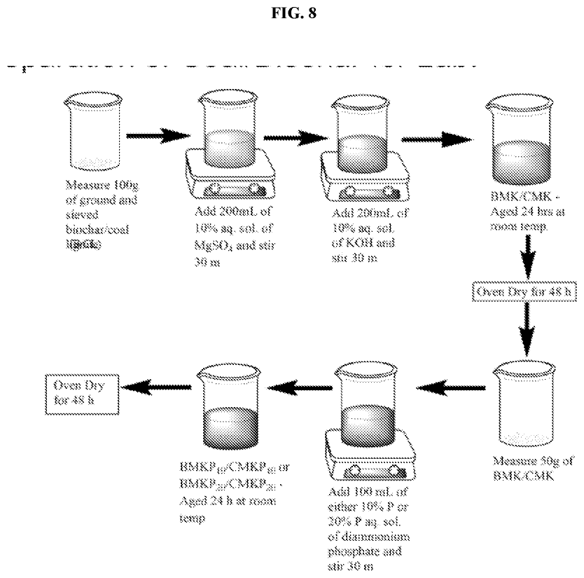

Phosphate-binding interactions on CTL were further characterized by XPS before and after P removal. CTL high resolution (HR) C1s XPS spectrum before P uptake contained five deconvoluted peaks assigned to C—C/C—H (284.3 eV), C—O (285.2 eV), C═O (286.2 eV), COOR (287.1 eV), and CO32- (290.0) (FIG. 6a). After phosphate uptake, the atomic percentages of COOH and CO₃²⁻ on CTL dropped (from 1.3% to 0.7% and from 2.1% to 0.7%) (FIGS. 6a and 6d). CaCO₃ dissolution at pH 2.2 explains the CO32- atomic percentage reduction. The CTL HR O1s XPS spectrum was deconvoluted into five peaks belonging to metal hydroxides (M-OH) (530.0 eV), metal oxides (M-O) (531.0 eV), C—O (531.8 eV), C═O (532.7 eV), and COOR/CO₃²⁻ (533.7 eV) (FIG. 6b). CTL surface 0 percentages of C═O and CO32- decreased from 17.9 to 10.2% and 12.8 to 7.7% after phosphate removal. These oxygen content decrements imply the oxidation resistance of Mg—Ca impregnated biochar was enhanced, contributing to its soil stability as previously described (Wu et al., 2019).

After phosphate uptake at pH 2.2, the low-resolution CTL survey spectrum exhibited a new 134.9 eV peak due to surface phosphate precipitation. The higher P atomic percentage of CTL (7.7%) versus RL (2.0%) and TL (4.3%) after phosphate uptake demonstrated CTL's greater phosphate sorption ability. There are two key processes involved in the phosphate uptake on Mg—Ca rich biochar; surface adsorption of phosphates (Yao et al., 2011) and Mg(H₂PO₄)₂, MgHPO₄, Ca(H₂PO₄)₂, and CaHPO₄ precipitation (Yao et al., 2013). However, the phosphate surface adsorption did not play a major role on CTL, as presented by SEM/EDX analysis; precipitation dominated.

The P-laden CTL Mg1a spectrum had four key peaks at 1302.6 eV, 1303.9 eV, 1304.9 eV, and 1305.8 eV (FIG. 6c), assigned respectively to Mg(OH)₂, MgO, Mg₃(PO₄)₂ and MgHPO₄ (Lin et al., 2019; Yao et al., 2013). This spectrum characterizes the surface Mg²⁺ deposition and crystalline Mg—P salts formation after P uptake. After CTL removes P at pH 2.2 from water, Mg(OH)₂ and MgO atomic percentages dropped from 2.0% to 0.2% and 3.6% to 1.0% (FIG. 6c), revealing dissolution of these species.

CTL has a very high PZC (˜13), and both MgO and Mg(OH)₂ have PZCs around pH 12. When the solution pH is below the PZC, the adsorbent surface is positively charged; MgO, and CaO (if present) can acquire surface hydroxyls, whereas Mg(OH)₂ can be protonated (Yao et al., 2011). At low pH, HPO₄²⁻/PO₄³⁻ electrostatically interact with protonated Mg(OH)₂ and MgO sites on CTL. Therefore, electrostatic interactions promote phosphate removal. Around a pH of approximately 4, P salts precipitate as MgHPO₄, Mg₃(PO₄)₂, and CaHPO₄. Lin et al., 2019 reported a similar Mg—P formation on the Mg(OH)₂/ZrO₂ surface during phosphate uptake.

After CTL's phosphate uptake, the M-OH surface region's oxygen percentage (for M=Al³⁺ or Si⁴⁺) decreased (from 3.5% to 2.6%). The phosphate binding caused a drop of M-OH oxygen percentage on CTL, consistent with SEM/EDX studies. The ratio between M-OH of the adsorbent before phosphate exposure versus the P-laden adsorbent M-OH can be 0.5 (monodentate complex) or 2 (bidentate complex). Here, that ratio is 1.3 (3.5%/2.6%), which is within the permitted range. Mononuclear monodentate, mononuclear bidentate and binuclear bidentate phosphate complexes can potentially form Al and Si bound surface hydroxyls on CTL, in agreement with Li et al., 2013. However, this inner sphere chemisorptive complexation is only a small fraction of the overall CTL phosphate uptake.

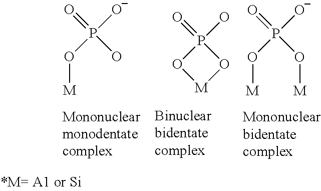

The HR—XPS Ca2p spectrum of P-laden CTL contains Ca2p3 peaks at 347.7 eV (CaO, CaHPO₄, Ca₃(PO₄)₂) and 348.5 eV (Ca₃(PO₄)₂, CaHPO₄), and a Ca2p1 peak at 349.5 eV (CaCO₃). This indicates the existence of Ca²⁺ on the surface and possible Ca²⁺/phosphate interactions (FIG. 6f) (NIST, 2012). Bulk elemental analysis of CTL also indicated a 1.5% wt. Ca content. CO₂ is released on CTL pyrolysis of CTL and reacts with surface Ca(OH)₂, giving CaCO₃ (Antunes et al., 2018). XRD analysis of the CTL exhibited the known (112) plane of CaCO₃ at 2θ=29.7° (FIG. 1b). The atomic percentage of Ca in CaCO₃ decreased (from 1.3% to 0.3%) after phosphate uptake (Table S11) at pH 2.2. At low pH, dissolution of CaCO₃ followed by phosphate precipitation as CaHPO₄ caused this reduction. CaCO₃ is highly soluble in an acidic medium (Table Si), where it contributes more to phosphorous uptake via released Ca²⁺. This Ca²⁺ formed brushite (CaHPO₄) or hydroxylapatite (Ca₅(PO₄)₃OH) precipitates (Antunes et al., 2018; Marshall et al., 2017). A new peak formation at 348.5 eV denotes CaHPO₄ (˜1.5%) precipitation on the CTL.

Overall, CTL's Mg²⁺ and Ca²⁺ contents greatly exceeded RL's Mg (12.4% vs. 0.5%) and Ca (4.8% vs. 1.0%) and produced high phosphate uptake. After removing P from water, the P surface region percentage from XPS quantifications was highest in CTL (7.7%) vs TL and RL (4.3% vs. 2.0%). The HR P2p XPS spectrum's peaks were assigned to the 1.0% MgHPO₄ (132.9 eV), 4.5% Mg₃(PO₄)₂ (133.9 eV), and 2.2% Ca₃(PO₄)₂, CaHPO₄ (135.0 eV). Ca²⁺ or Mg²⁺/HPO₄²⁻ complexes are thermodynamically more stable than H₂PO₄⁻ and interact with the positively charged adsorbent surfaces. Precipitation of CaHPO₄, Ca₃(PO₄)₂ MgHPO₄, and Mg₃(PO₄)₂ on the CTL surface increases surface P percentages as described above. In summary, CTL phosphate remediation proceeds largely via precipitation of Ca²⁺ and Mg²⁺ salts originally released by CTL (Equations 1-4). At high pH (>9) speciation favors PO₄₃, so Ca₃(PO₄)₂ was precipitated (Equation 4). The electrostatic interaction of protonated surfaces with HPO₄²⁻ and PO₄³⁻ species contributes CTL's P uptake under environmental pH levels (pH=6-9).

Mg(OH)₂+HPO₄²⁻→MgHPO₄ (1)

3Mg(OH)₂+2PO₄³⁻→Mg₃(PO₄)₂ (2)

Ca(OH)₂+HPO₄²⁻→CaHPO₄ (3)

3Ca(OH)₂+2 PO₄³⁻→Ca₃(PO₄)₂ (4)

### Systems and Processes

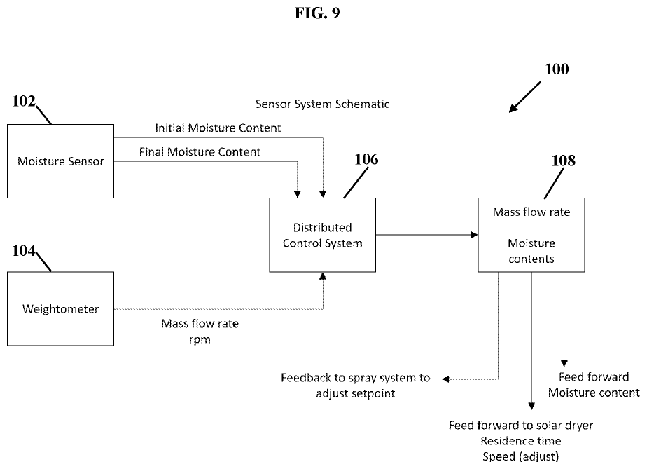

Turning to FIGS. 9-11, example embodiments of a sensor system is shown in accordance with the present disclosure. At FIG. 9, the sensor system 100 includes a moisture sensor 102, weightometer 104, control system 106, and mass flow rate 108. The moisture sensor 102 determines the wetness or dryness of material, and can be a capacitance or resistance type sensor, or a laser sensor. The wetness or dryness of the material (i.e., how much water there is in the material) is determined by a moisture sensor 102 after the material is ground to the specific sizes. Accordingly, the moisture sensor 102 provides an initial moisture content (i.e., before grinding) and final moisture content (i.e., after grinding) to the control system 106.

The weightometer 104 measure the weight of the material and outputs a mass flow rate (rotations per minute) to the control system 106. The weightometer (measures weight) and has an integrator disc that integrates both variables perfectly because the integrator registering disc instantaneously reacts to variations of weight, and corresponds at all times to, the true position of the scale beam; also, the true speed of the conveyor is at all times transmitted to the integrator belt. For these reasons, the remarkable accuracy of weighing with the weightometer is consistent and assures accuracy. The control system 106 receives the initial moisture content and final moisture content from the moisture sensor 102, and receives the mass flow rate from the weightometer 104. Based on that information, the control system 106 determines the weight of the material and a data signal processor 108 sends a control signal with a desired mass flow rate to adjust the speed of the spray system, i.e., how much liquid is to be sprayed on the material. This provides feedback to the spray system to adjust the flow setpoint. That information also includes residence time, which can be provided to a solar dryer. The mass flow rate is weight measured and adjusted to the speed of the conveyor belt.

Thus, the wetness or dryness of the material is defined by the moisture content. The weight of the material is influenced by the amount of water in the product, which in turn influences the flow. Thus, the weightometer 104 determines the flow of the material to the spray system and the amount of liquid to be sprayed on the material. The flow is based on the amount of water, which is based on the weight. The control system 106 gives the feedback to the spray system. This method provides an environmentally sound determination of putting the exact amount of liquid on the material from the spray system to the material.

The Moisture Meter Process includes Conveying, Measuring, Regulating. The Moisture Meter measures the water in the material to output an electrical signal. The weightometer (measures weight) and has an integrator disc integrates both variables perfectly because the integrator registering disc instantaneously reacts to variations of, weight) and corresponds at all time to, the true position of the scale beam. The mass flow (weight measured by the weightometer equipped with an integrator disc which tell the speed of the conveyor belt (adjusting the speed according to weight). Distributed control continuously monitors and adjust the process of the spray system to the exact amount of Liquid 1 needed.

It is noted that the distributed control system 106 can include a processing device to perform various functions and operations in accordance with the disclosure. The processing device can be, for instance, a computer, personal computer (PC), server or mainframe computer, or more generally a computing device, processor, application specific integrated circuits (ΔSIC), or controller. The processing device can be provided with one or more of a wide variety of components including, for example, wired or wireless communication links, input devices (such as touch screen, keyboard, mouse) for user control or input, monitors for displaying information to the user, and/or storage device(s) such as memory, RAM, ROM, DVD, CD-ROM, analog or digital memory, flash drive, database, computer-readable media, floppy drives/disks, and/or hard drive/disks. All or parts of the system, processes, and/or data utilized in the system of the disclosure can be stored on or read from the storage device(s). The storage device(s) can have stored thereon machine executable instructions for performing the processes of the disclosure. The processing device can execute software that can be stored on the storage device. Unless indicated otherwise, the process is preferably implemented automatically by the processor substantially in real time without delay.

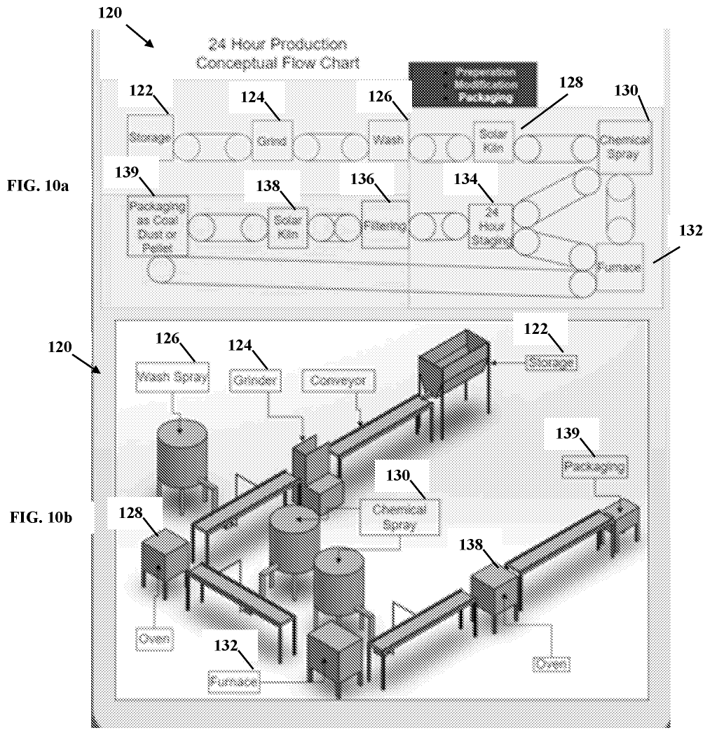

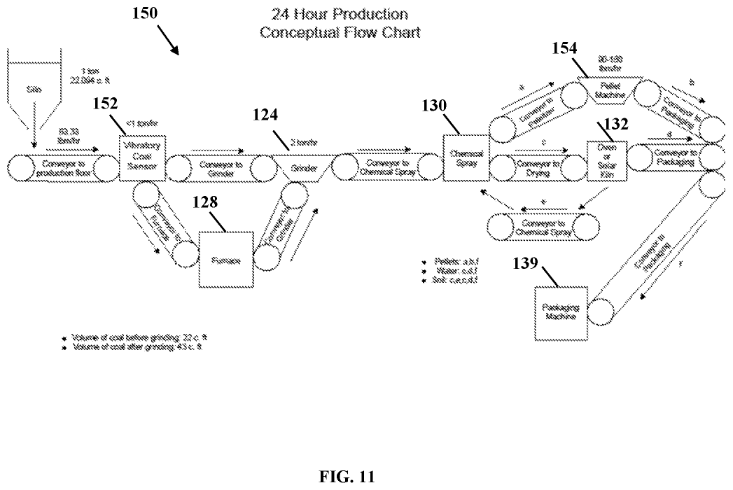

Turning to FIGS. 10a, 10b, 11, a 24-hour production flow chart is shown. Here, the production process 120 includes a storage 122, grinder 124, wash 126, solar kiln 128, chemical spray 130, furnace 132, 24-hour staging 134, filtering 136, solar kiln 138, and packaging 139 as coal dust or pellets. A transport mechanism, such as a conveyor belt, can be provided between neighboring components to transport material from one production step to the next. As shown, components 122, 124, 126 are for preparation of the material, components 128, 130, 132, 134 are for modification of the material, and components 136, 138, 139 are for packaging of the material. The drying time is a function of the moisture content. If the material has a high moisture content, then wetter and the longer time drying to the target moisture content. The controller controls the total process, conveying.

Starting with preparation of the material, the material is retrieved from the storage 122, such as a silo (FIG. 11), and transported to the grinder 124. The grinder 124 grinds the material and the grind material is transported to be washed by the wash 126. The washed material undergoes a modification process, where the washed material is first dried by the solar kiln 128, and a chemical spray 130 is applied. The material may then be pyrolyzed at the furnace 132 and/or sent to staging 134. Material from the furnace 132 can be packaged as coal dust or pellet 139. Material from the staging area 134 can be packaged by being filtered by a filter 136, dried by the kiln 138, and packaged as coal dust or pellets 139.

As further shown in the system 150 of FIG. 11, a vibratory coal sensor 152 can be provided to receive product from the storage silo, then sort the product to either the grinder 124 or first to the furnace 128 to dry and then to the grinder 124. The material is then transported to the chemical spray 130. The sprayed material can then be formed into pellets by a pellet machine 154, and packaged by a packaging machine 139. Or product can be provided from the chemical spray 130 to the oven 132. It can then be sprayed again at spray 130, and eventually passed to the packaging machine 139.

The system is environmentally friendly and cost effective using the exact quantity of spray and not overdrying the product in the solar dryer so less degrade in the product.

### Examples

### Materials and Methods

Lignite was provided by the Mississippi Lignite Mining Company (Red Hills Mine, Ackerman, MS, USA). Raw lignite (RL) was washed thoroughly with deionized water to remove extraneous materials such as dirt, sand, and other impurities, followed by oven drying at 80° C. for 48 h (1 atm, air). The dried lignite was ground into fine particles using a high-speed multifunctional grinder (CGOLDENWALL, China, 2500 W, 36000/min, model no: HC150T2) and sieved to 150-300 μm. A high SiO₂ fraction was (19.9%) in this lignite's ash (total 25.0%). All chemicals used, including magnesium sulfate, calcium sulfate hemihydrate, potassium hydroxide, concentrated sulfuric acid, ammonium molybdate, and ascorbic acid, were analytical grade and purchased from Sigma Aldrich.

Preparation of Ca²⁺ and Mg²⁺ Loaded Lignite Adsorbent (CTL)

RL (100 g), washed and dried, was treated (impregnated) with a single solution of MgSO₄ and CaSO₄ formed by combining two solutions prepared separately. A 10% aqueous MgSO₄ solution (10 g of MgSO₄ [0.083 mol] dissolved in 100 mL of water, [1.992 g of Mg]) was prepared. Then a 10% aqueous solution of CaSO₄·½ H₂O (10 g of CaSO₄·½ H₂O [0.069 mol] dissolved in 100 mL of water, [2.76 g of Ca]) was made and added to the MgSO₄ solution. Next, a 1.5 M aqueous KOH (350 mL, 29.4 g of KOH, 13.9% wt. of K) was added to the combined MgSO₄ and CaSO₄·½H₂O solution to adjust the pH to ˜13.9. RL (100 g) was stirred in the Ca²⁺— Mg²⁺ and KOH containing solution for 1 hour and aged for 24 hours. Then, the resulting slurry was transferred into watch glasses. These slurries were then oven-dried (1 atm, 105° C., 4 hours) and vacuum oven-dried (0-4.9 atm, 60° C. for overnight). The dried material weighs 139.2 g. This was then pyrolyzed at 600° C. in a muffle furnace under nitrogen at a 20° C./min ramp rate to 600° C., followed by holding at 600° C. for 1 hour. This temperature was chosen according to Takaya et al., 2016. The resulting solid (wt. 89.0 g) was washed with DI water, oven-dried (1 atm, 80° C. overnight), giving a solid (53.9 g). This weight difference showed that substantial amounts (35.1 g) of soluble Ca², Mg², and K⁺ compounds were removed. This resulting CTL was crushed to particle sizes smaller than 0.3 mm. CTL was then sieved into three particle sizes (<150 μm, 150 μm-300 μm, and >300 μm) and stored in air-sealed containers for future characterization and adsorption experiments. An as-received raw lignite sample (100 g) was identically pyrolyzed at 600° C., without adding any Ca/Mg chemicals, generating thermally-treated lignite (TL) (59.5 g) to compare with CTL and RL, after a wt. loss of 40.5 g.

### Characterization Techniques

Surface areas, DFT pore sizes, pore volumes, and micropore volumes of RL, TL, and CTL were determined. The surface areas were measured using N₂ and CO2 physisorption using the BET method run on a Micromeritics Tristar II Plus surface analyzer. Scanning electron microscopy (SEM) was performed using a Carl Zeiss EVO50VP Variable Pressure Scanning Electron Microscope with an accelerating 15 kV voltage. A JEOL 2100 200 KV TEM with Oxford X-max 80 EDS detector was used to evaluate the CTL's inner morphology. Surface region (depth of 3.1 μm) elemental distribution was determined by Energy-dispersive X-ray spectroscopy using a Bruker Quantax 200 X Flash EDX Spectrometer System (LN2-free high-speed 30 mm² SDD Detector) under a magnification 150×, employing an interaction diameter of ˜3.8 μm. Surface chemistry was studied using X-ray photoelectron spectroscopy to elucidate elements present and their oxidation states to a maximum detection depth of 80 Å. XRD analysis was performed on RL, TL, and CTL to a penetration depth of 0.5 mm and a spot size of 1 cm². An ECS 4010 elemental combustion system (Costect Analytical Technologies Inc.) was used to analyze the C, H, and N composition. The samples were oven-dried for 2 hours at 105° C. before assessing their moisture contents. The samples were heated in air in a muffle furnace at 750° C. for 4 hours in an uncovered porcelain dish to determine their ash contents. Organic oxygen percentage was calculated by (100−[C+H+N+ash]). NaCl solutions, adjusted from pH 2-12 using 1 M HNO₃ and 1 M NaOH, were used with a pH meter to determine the adsorbents' point of zero charges (PZC). Total Mg and Ca loadings of CTL were determined using AAS after complete acid digestion with 1:1 95% H²SO⁴/70% HNO³ (50 mL).

### Adsorption Experiments

Unless otherwise specified, a 0.05 g adsorbent dose, 50 ppm phosphate concentration, and 25 mL solution volume were used in batch experiments without a pH adjustment (pH=5.5). This initial pH changed due to leaching of Ca²⁺/Mg²⁺ from the CTL, as presented in section 3.4.2. Batch experiments were conducted in a Thermo Forma Orbital Shaker (200 rpm, 25±0.5° C.) for 24 h to achieve equilibrium. The vials were removed after the shaking period, and the suspensions were filtered through Whatman 1001-110 Qualitative filter papers (11.0 cm diameter, pore size, 11 μm). Three replicates of each experiment were performed. Solution pH was determined before and after adsorption. The residual phosphate concentrations in the filtrates were determined calorimetrically by following the reduction of the blue-colored molybdenum phosphate complex at 830 nm using a Shimadzu, UV-2550 double beam Spectrophotometer. The analysis was conducted according to the ascorbic acid method of Lozano-Calero.

Phosphate sorption versus pH was determined by varying the solution pH from 2.2 to 11.5 by dropwise addition of 1 M HCl or 1 M NaOH. Kinetic experiments employed samples containing 50 ppm phosphate concentrations, collected at preselected times (5 min. up to 24 h). Adsorption isotherm experiments were conducted using 25-1000 ppm phosphate solutions under the optimum adsorption pH (˜2.2) and practically important pH level (pH-7) at 25, 30, and 40±0.5° C. for 24 h.

Calcium and Magnesium Leaching from CTL

A control experiment was conducted to investigate Ca²⁺ and Mg²⁺ leaching into DI water at pH 2.2. Washed CTL (0.1 g) was added into 50 mL DI water (without phosphates) at pH 2.2. This suspension was stirred for 24 hours at 25° C. (200 rpm), filtered, and the filtrates were quantified using AAS for leached Ca and Mg amounts.

### CTL Regeneration, Reuse and Desorption Kinetics

The regeneration tests for P-laden washed CTL and P-laden unwashed CTL were conducted using an aqueous NaOH stripper and performed according to Du et al., 2019 with a minor modification. CTL (1.5 g) was first equilibrated with 750 mL of 1000 ppm phosphate solution in a mechanical shaker (200 rpm, 25° C., 24 hours) at pH 7. After phosphate uptake, the suspension was filtered, and the P-loaded CTL was washed with DI water (˜50 mL) to remove traces of unadsorbed P and only H-bonded phosphate on the CTL surface. After oven-drying (1 atm, 2 hours, 105° C.), P-loaded CTL was desorbed using a 1 M NaOH (10 mL, 25° C.) stripping treatment while stirring in a single batch. The filtrates were analyzed for released phosphate concentrations using the same colorimetric technique as previously described. Four adsorption-desorption cycles were performed. Since NaOH was not a potent phosphate stripping agent, both washed CTL and unwashed CTL sorbents were subjected to acidic stripping (FIGS. 5c and d). Initially, a 1000 ppm phosphate solution (750 mL for both) was used to load P onto 1.5 g of each adsorbent at pH 7. Desorption was performed using 0.5 M HCl (10 mL) as the stripping agent.

A desorption kinetic study was conducted on P-laden washed CTL. Initially, phosphate was adsorbed onto CTL (0.6 g) from a solution (100 ppm, 300 mL) in a plastic bottle during vigorous shaking for 24 h (pH 7, 25° C., 200 rpm). This suspension was filtered; the P-loaded CTL was washed with DI water (˜150 mL) to remove unadsorbed P and then oven-dried (1 atm, 105° C.) overnight. A series of 100 mL DI water samples (pH=6.5, 7.0, and 7.5) were prepared, and P-loaded CTL (0.15 g) was added to each. Samples (1 mL aliquots) were removed on consecutive days, and leached phosphate concentrations were determined as described in section 2.3. The pH of the DI water was also measured each day.

### REFERENCES

The following references may be pertinent to this disclosure.
Bowen, B. H., Irwin, M W., 2008. COAL CHARACTERISTICS.
Biochar Support as a Basic Catalyst for Glucose Isomerization. ACS Sustain. Chen. Eng. 8, 6990-7001. https://doi.org/10.1021/acssuschemeng.0c00278
de Jonge, H., Mittelmeijer-Hazeleger, M. C., 1996. Response to Comment on “Adsorption of CO2 and N2 on Soil Organic Matter: Nature of Porosity, Surface Area, and Diffusion Mechanisms.” Environ, Sci. Technol. 30, 3636-3637. https://doi.org/10.1021/es962011r
Karunanayake, A. G., Navarathna, C. M., Gunatilake, S. R., Crowley, M., Anderson, R., Mohan, D., Perez, F., Pittman, C. U., Jr., Mlsna, T., 2019. Fe₃O₄ Nanoparticles Dispersed on Douglas Fir Biochar for Phosphate Sorption. ACS Appl. Nano Mater. 2, 3467-3479. https://doi.org/10.1021/acsanm.9b00430
Katsou, E., Malamis, S., Tzanoudaki, M., Haralambous, K. J., Loizidou, M., 2011. Regeneration of natural zeolite polluted by lead and zinc in wastewater treatment systems. J. Hazard. Mater., Selected papers presented at the 2nd International Conference on Research Frontiers in Chalcogen Cycle Science and Technology, Delft, The Netherlands, May
Li, R., Wang, J. J., Zhou, B., Awasthi, M. K., Ali, A., Zhang, Z., Gaston, L. A., Lahori, A. H., Mahar, A., 2016a. Enhancing phosphate adsorption by Mg/Al layered double hydroxide functionalized biochar with different Mg/Al ratios. Sci. Total Environ. 559, 121-129. https://doi.org/10.1016/j.scitotenv.2016.03.151
Lin, J., He, S., Wang, X., Zhang, H., Zhan, Y., 2019. Removal of phosphate from aqueous solution by a novel Mg(OH)2/ZrO2 composite: Adsorption behavior and mechanism. Colloids Surf. Physicochem. Eng. Asp. 561, 301-314. https://doi.org/10.1016/j.colsurfa.2018.11.001
Marshall, J. A., Morton, B. J., Muhlack, R., Chittleborough, D., Kwong, C. W., 2017. Recovery of phosphate from calcium-containing aqueous solution resulting from biochar-induced calcium phosphate precipitation. J. Clean. Prod. 165, 27-35. https://doi.org/10.1016/i.jclepro.2017.07.042
Milicevic, S., Boljanac, T., Martinovic, S., Vlahovic, M., Milosevic, V., Babic, B., 2012. Removal of copper from aqueous solutions by low cost adsorbent-Kolubara lignite. Fuel Process. Technol. 95, 1-7. https://doi.org/10.1016/i.fuproc.2011.11.005
Mohan, D., Pittman, C. U., Jr., 2006. Activated carbons and low cost adsorbents for remediation of tri- and hexavalent chromium from water. J. Hazard. Mater. 137, 762-811.
Qi, Y., Hoadley, A. F. A., Chaffee, A. L., Gamier, G., 2011. Characterisation of lignite as an industrial adsorbent. Fuel 90, 1567-1574. https://doi.org/10.1016/i.fuel.2011.01.015
Quartz R100134—RRUFF Database [WWW Document], 2020. URL https://rruff.info/Quartz/R100134 (accessed 10.30.20).
   Simate, G. S., Maledi, N., Ochieng, A., Ndlovu, S., Zhang, J., Walubita, L. F., 2016. Coal-based adsorbents for water and wastewater treatment. J. Environ. Chem. Eng. 4, 2291-2312. https://doi.org/10.1016/i.jece.2016.03.051
Sugiyama, S., Yokoyama, M., Ishizuka, H., Sotowa, K.-I., Tomida, T., Shigemoto, N., 2005. Removal of aqueous ammonium with magnesium phosphates obtained from the ammonium-elimination of magnesium ammonium phosphate. J. Colloid Interface Sci. 292, 133-138. https://doi.org/10.1016/i.jcis.2005.05.073
Takaya, C. A., Fletcher, L. A., Singh, S., Okwuosa, U. C., Ross, A. B., 2016. Recovery of phosphate with chemically modified biochars. J. Environ. Chem. Eng. 4, 1156-1165. https://doi.org/10.1016/j.jece.2016.01.011
Wu, B., Wan, J., Zhang, Y., Pan, B., Lo, I. M. C., 2020. Selective Phosphate Removal from Water and Wastewater using Sorption: Process Fundamentals and Removal Mechanisms. Environ. Sci. Technol. 54, 50-66. https://doi.org/10.1021/acs.est.9b05569
Wu, L., Wei, C., Zhang, S., Wang, Y., Kuzyakov, Y., Ding, X., 2019. MgO-modified biochar increases phosphate retention and rice yields in saline-alkaline soil. J. Clean. Prod. 235, 901-909. https://doi.org/10.1016/j.jclepro.2019.07.043
Wuthier, R. E., Rice, G. S., Wallace, J. E., Weaver, R. L., LeGeros, R. Z., Eanes, E. D., 1985. In vitro precipitation of calcium phosphate under intracellular conditions: formation of brushite from an amorphous precursor in the absence of ATP. Calcif. Tissue Int. 37,
Yang, Q., Wang, X., Luo, W., Sun, J., Xu, Q., Chen, F., Zhao, J., Wang, S., Yao, F., Wang, D., Li, X., Zeng, G., 2018. Effectiveness and mechanisms of phosphate adsorption on iron-modified biochars derived from waste activated sludge. Bioresour. Technol. 247, 537-544. https://doi.org/10.1016/j.biortech.2017.09.136
Yao, Y., Gao, B., Chen, J., Yang, L., 2013. Engineered Biochar Reclaiming Phosphate from Aqueous Solutions: Mechanisms and Potential Application as a Slow-Release Fertilizer. Environ. Sci. Technol. 47, 8700-8708. https://doi.org/10.1021/es4012977
Yao, Y., Gao, B., Inyang, M., Zimmerman, A. R., Cao, X., Pullammanappallil, P., Yang, L., Removal of phosphate from aqueous solution by biochar derived from anaerobically digested sugar beet tailings. J. Hazard. Mater. 190, 501-507. https://doi.org/10.1016/j.jhazmat.2011.03.083
Yin, Q., Ren, H., Wang, R., Zhao, Z., 2018. Evaluation of nitrate and phosphate adsorption on Al-modified biochar: Influence of Al content. Sci. Total Environ. 631-632, 895-903. https://doi.org/10.1016/j.scitotenv.2018.03.091
Yin, Q., Zhang, B., Wang, R., Zhao, Z., 2017. Biochar as an adsorbent for inorganic nitrogen and phosphorus removal from water: a review. Environ. Sci. Pollut. Res. 24, 26297-26309. https://doi.org/10.1007/s11356-017-0338-v
Zhang, J., Hu, X., Zhang, K., Xue, Y., 2019. Desorption of calcium-rich crayfish shell biochar for the removal of lead from aqueous solutions. J. Colloid Interface Sci. 554, 417-423. https://doi.org/10.1016/j.jcis.2019.06.096
Zhang, M., Gao, B., Yao, Y., Inyang, M., 2013. Phosphate removal ability of biochar/MgAl-LDH ultra-fine composites prepared by liquid-phase deposition. Chemosphere 92, 1042-1047. https://doi.org/10.1016/j.chemosphere.2013.02.050
Zhang, M., Gao, B., Yao, Y., Xue, Y., Inyang, M., 2012. Synthesis of porous MgO-biochar nanocomposites for removal of phosphate and nitrate from aqueous solutions. Chem
Zhang, R., Wang, B., Ma, H., 2010. Studies on Chromium (VI) adsorption on sulfonated lignite. Desalination 255, 61-66. https://doi.org/10.1016/j.desal.2010.01.016
Zhang, Y., Guo, X., Yao, Y., Wu, F., Zhang, C., Lu, J., 2016. Synthesis of Mg-Decorated Carbon Nanocomposites from MesoCarbon MicroBeads (MCMB) Graphite: Application for Wastewater Treatment. ACS Omega 1, 417-423. https://doi.org/10.1021/acsomega.6b00073
Zhao, L., Guanhua, N., Hui, W., Qian, S., Gang, W., Bingyou, J., Chao, Z., 2020. Molecular structure characterization of lignite treated with ionic liquid via FTIR and XRD spectroscopy. Fuel 272, 117705. https://doi.org/10.1016/j.fuel.2020.117705
Zhong, C., Deng, Y., Hu, W., Qiao, J., Zhang, L., Zhang, J., 2015. A review of electrolyte materials and compositions for electrochemical supercapacitors. Chem. Soc. Rev. 44, 7484-7539. https://doi.org/10.1039/C5CS00303B
Zhou, H., Jiang, Z., Wei, S., 2013. A Novel Absorbent of Nano-Fe Loaded Biomass Char and Its Enhanced Adsorption Capacity for Phosphate in Water [WWW Document]. J. Chen http://doi.org/10.1155/2013/649868

The description of the present embodiments of the invention has been presented for purposes of illustration but is not intended to be exhaustive or to limit the invention to the form disclosed. Many modifications and variations will be apparent to those of ordinary skill in the art. As such, while the present invention has been disclosed in connection with an embodiment thereof, it should be understood that other embodiments may fall within the spirit and scope of the invention.

All patents and publications cited herein are incorporated by reference in their entirety.

1. A process for preparing a modified lignite, the process comprising
(i) reacting raw lignite with a source of Mg²⁺ ions and a source of Ca²⁺ ions;
(ii) optionally further reacting the lignite with a source of K⁺ ions;
(iii) optionally drying the treated lignite; and
(iv) pyrolyzing the treated lignite, thereby producing the modified lignite.

2. The process of claim 1, further comprising
(v) washing the modified lignite; and
(vi) drying the product of step (v).

3. The process of claim 1, wherein the source of Mg²⁺ ions is selected from MgSO₄, MgO, Mg(OH)₂, MgCl₂, or any combination thereof.

4. The process of claim 1, wherein the source of Ca²⁺ ions is selected from CaSO₄, CaO, Ca(OH)₂, CaCl₂), or any combination thereof.

5. The process of claim 1, wherein the source of K⁺ ions is selected from KOH, KCl, or any combination thereof.

6. The process of claim 1, wherein step (iii), if performed, is conducted at a temperature of about 105° C.

7. The process of claim 1, wherein, step (iii), if performed, is conducted for about 4 hours.

8. The process of claim 1, wherein step (iv) is conducted at a temperature of about 600° C.

9. The process of claim 1, wherein step (v), if performed, involves washing the modified lignite with water.

10. The process of claim 1, wherein the process further comprises
(vii) reducing the particle size of the modified lignite.

11. The process of claim 1, wherein the modified lignite has a particle size of between about 150 microns and about 300 microns.

12. The process of claim 1, wherein the modified lignite has a particle size of less than about 150 microns.

13. The process of claim 1, wherein the modified lignite has a particle size of greater than about 300 microns.

14. A process for reducing the amount of phosphate in a solution the process comprising contacting the solution with a modified lignite prepared by a process according to claim 1.

15. A process for removing agricultural waste from a solution, the process comprising contacting the solution with a modified ignite prepared by a process according to claim 1.

16. The process of claim 14, further comprising regenerating the modified lignite.

17. The process of claim 16, wherein the process comprises
(ii) removing the phosphorous laden modified lignite from the solution;
(iii) washing the phosphorous laden modified lignite with water to remove unadsorbed phosphate and only hydrogen bonded phosphate on the lignite surface;
(iv) drying the product of step (iii);
(v) washing the product of step (iv) with an alkali or an acid, thereby regenerating the modified lignite; and
(vi) drying the product of step (v).

18. A process for preparing a fertilizer and/or soil amendment, the process comprising:
(i) reacting raw lignite with a source of Mg²⁺ ions and a source of Ca²⁺ ions;
(ii) optionally further reacting the lignite with a source of K⁺ ions;
(iii) optionally drying the treated lignite; and
(iv) pyrolyzing the treated lignite;
(v) contacting the product of step (iv) with a solution containing phosphorous;
(vi) allowing the treated lignite to adsorb phosphorous from the solution; and
(vii) drying the product of step (vi).

19. A fertilizer and/or soil amendment prepared by the process of claim 18.
